(19) United States
(12) Patent Application Publication
(10) Pub. No.: US 2011/0141918 A1
(43) Pub. Date: Jun. 16, 2011

(54) TIME DIVISION MULTIPLEXING METHOD AND SYSTEM

(75) Inventor: Daoben Li, Shenzhen (CN)

(73) Assignee: Research Institute of Tsinghua University in Shenzhen, Shenzhen (CN)

(21) Appl. No.: 12/558,536

(22) Filed: Sep. 13, 2009

(51) Int. Cl. H04J 3/02; H04L 12/26; H04J 3/06

(52) U.S. Cl. 370/252; 370/498; 370/503

(57) ABSTRACT

The present invention provides the method and system of a Time Division Multiplexing which makes use of a number of symbols in the time domain transmitting data sequence in parallel. The method includes: the transmitting terminal forms the transmission signals which are overlapped by a number of symbols in the time domain, and the receiving terminal does data sequence detection in the time domain for the received signals according to the one-to-one relationship between the transmission data sequence and the time waveform of the transmission data sequence. In addition, the present invention also provides a kind of Time Division Multiplexing system based on the above method of the Time Division Multiplexing. The present invention makes actively use of these overlapping to produce the coding constraint relation, thus the spectral efficiency of the system is improved by a large margin. In random time-varying channel, with reasonable arrangement, the transmission reliability of the system can also be improved at the same time, and at the same threshold, Signal Interference Ratio and its spectral efficiency are far higher than those of the high-dimension modulation and other technologies. At the same spectrum efficiency, the number of the total levels of its systems and the needed threshold Signal Interference Ratio are also reduced significantly than those of the high-dimension modulation and other technologies.

### BACKGROUND OF THE INVENTION

1. Field of the Invention

This invention related to the field of Digital Communications, especially on multiplexing technique which is effective, reliable, practical and innovative with super-high spectral efficiency. Specifically, it is mainly about the method and system of time division multiplexing technology.

2. Description of the Related Art

IMT (international mobile telecommunications)—Advanced, the new standard for the future mobile communications, is currently proposed by ITU (international telecommunications union), and many International Standardization Organizations are all actively targeting the goal of future mobile communication, and scheduling the timetable for the system implementation. ITU predicts that the future system with the new standard can support the peak rate of up to 100 Mbps in the high-speed mobile and harsh transmission environment and 1 Gbps in low-speed mobile and good transmission environment and meet the needs of the global personal communications around the year 2010.

However, the frequency spectrum resources used for mobile communications are very limited. It is very difficult to meet the explosive growth of the communication traffic requirements by the current technical solutions or even the theoretical concepts with such limited resources, which requires the new innovation and breakthrough in wireless communications from the theoretical and technical perspective to solve the problems, so that the spectrum efficiency, capacity and data rate can be improved in at least one order of magnitude.

The spectral efficiency is defined as the maximum (peak) bit transmission rate each space channel can support in the system when the bandwidth of the system is given, and the metric is bps/Hz/antenna (bps/Hz/Antenna).

As we all know, the bandwidth of a non-spread spectrum communication system depends on the length or the rate of the transmission symbols it uses. If the length of the symbols is Ts (seconds), then the rate of the symbols is

$$\frac{1}{{T}_{s}} ( Symbols \text{/} second ) ,$$

the bandwidth of the system it occupied is

$$\frac{1 + α}{{T}_{s}} ( Hz ) ,$$

α is the roll-off coefficient of the system filer (0<α≦1). In order to improve the spectral efficiency of the system, the high-dimension modulation which also called multi-dimension (multi-level) modulation is generally used, so as to carry more information bits for each symbol. For example, when using the binary modulation binary phase shift keying (BPSK) or binary amplitude shift keying (2ASK) for the modulation signal, each symbol can carry a bit, the spectral efficiency of the system is

$$\frac{1}{1 + α} ( bps \text{/} Hz \text{/} antenna ) .$$

When using the four-phase modulation quadrature phase shift keying (QPSK), differential quadrature phase shift keying (DQPSK), π/4 quadrature phase shift keying (π/4QPSK) or quadrature amplitude shift keying (4ASK), each symbol can carry 2 bits, the spectral efficiency of the system is improved by twice to

$$\frac{2}{1 + α} ( bps \text{/} Hz \text{/} antenna )$$

compared with the binary modulation. In general, if using the dimension of M=2^{Q} (M≧2) modulation signal, each symbol can carry Q=log₂ M bits, the spectral efficiency of the system is

$$\frac{{log}_{2} M}{1 + α} = \frac{Q}{1 + α} ( bps \text{/} Hz \text{/} antenna ) .$$

The result was generally considered to be insurmountable “engineering theory boundary” by the professionals in the field of communication engineering. But there is still a far distance between this “boundary” and the real theory boundary (also known as Shannon limit) which is log₂(1+SIR) (bps/Hz/antenna), in which SIR is the threshold signal interference ratio of the system required. And the higher the spectral efficiency, the greater the distance between the two boundaries.

The main shortcomings of using high-dimension modulation to improve the spectral efficiency of the system are as follows: With the increase of spectral efficiency, namely the increase of number of signal level, the requirements for the channel characteristics and the transceiver characteristics increase when the linear channels need to have high requirements, the number of M-level requirements become more stringent. It requires not only an excellent amplitude—amplitude (that is, Am-Am) linearity, but also an excellent amplitude—phase (that is Am-Pm) linearity. As we all know, the better the linearity of the amplifier, the lower the power efficiency. In order to get a good linearity amplifier, some technique means such as complex adaptive linear compensation and significant power back-off must be used; In addition, the multi-level modulation requires not only high degree of nonlinear distortion, but also high degree of linear distortion. Engineering and experts know that, the actual channel keep changing, and it is difficult to maintain the transfer function in accordance with the expected ideal signal characteristics of the multi-dimension modulation, and any non-ideal linear transfer function (amplitude of frequency response, phase frequency response) will easily cause the merger of the system “eye diagram”. After the merger of the “eye diagram”, even though there is no interference in the system, and no matter how good the linearity of the system is, it cannot distinguish between signals with different level. And the higher the bit transmission rate is, the more the number of signal levels, and easier the merger of the “eye diagram”. Therefore, in the high-speed data communication systems with high-dimension modulation, without exception, the technique of complex fast adaptive channel equalization and/or the corresponding signal processing are used to avoid the merger of the system “eye diagram”. These issues as mentioned above are particularly serious in random time-varying channel, such as variety kinds of wireless communications, mobile communications, scattering communication, over-the-horizon communications, underwater acoustic communications, atmospheric optical communications, infrared communications. In these communication channels, the linear transfer function of the channels changes random with the space, frequency and time. And sometimes the change is so fast and the amplitude is so great that the technique of the channel equalization and signal processing cannot deal with it. That is why the high-dimension modulation with M≧4 seldom used in the communication systems which was random and time-variant. But precisely for the communication in this kind of channel, as the available spectrum resources is limited, there is more emphasis and higher demands on the spectral efficiency.

The information processing theory in the basic information theory tells us that any preprocessing of the linear transfer function H(t, f) of the system will definitely reduce the theoretical channel capacity which is the potential channel capacity, should be kept original. And the preprocessing technical means done for the channel transfer function such as equalization will greatly reduce the potential capacity of the channel. Therefore, the high-dimension modulation scheme is absolutely not a good transmission technique with high spectral efficiency.

The Time Division Multiplexing (TDM) is a technique that numbers of signal symbol occupying narrow time duration share a wider time duration. The traditional Time Division Multiplexing is shown in FIG. 1.

In FIG. 1, the time duration of the multiplexed signal symbols (which called time slot width in engineering) are T1, T2, T3, T4, . . . , with the same time slot width. ΔT is the minimal protection time slot, the actual time slot width should be more wider. The time slot width ΔT should be greater than the sum of the transition time of the de-multiplexing gate circuit and the maximum time jitter value of the system. This is the most common technique of time multiplexing. Currently, the technology is most used in multi-path digital broadcasting and communication systems.

The most important feature of this technology used in digital communication system is that the multiplexed signal symbols are completely isolated in time. There is no interference between them, and no restriction to the multiplexed signal symbols. The time duration of the signal symbols (time slot width) can be different and it also applies to communication systems. The only requirement is that the time slot cannot be overlapping and crossing. However, this kind of multiplexing itself doesn't play any role to improve the spectral efficiency of the system.

The Time Division Multiplexing TDM is generally applicable to multi-path digital communication which requires that the multiplexed signal symbols must be strictly synchronous. Virtually, it is a kind of parallel transmission for the multi-user data. Currently, it is widely used in the multi-path digital broadcasting and multi-path digital communication systems. In the random time-varying channel, as a result of the diffusion of the time (multi-path spread) in the channel, the width of each time slot should be greater than the sum of the signal symbol width and the maximum diffusion of the time in the channel. Otherwise, there is interference between all the signal symbols of the adjacent time slot. As a result, in the random time-varying channels, the narrowest time slot of the TDM system will be limited by the maximum diffusion of the time in the channel. In addition, the most important thing is that the spectral efficiency of TDM system only depends on the number of the modulation signal in each time slot. So it is a very difficult task to improve the spectral efficiency, especially in the random time-varying channels.

Overlapping between the symbols is the inter-symbol interference which is a serious issue in engineering. It is well known that once there is inter-symbol interference, the so-called “eye diagram merging” will occur, and the error probability of the system will increase sharply. In the engineering, equalization is generally used to eliminate the inter-symbol interference. The related references are as follows:
Forney G. D., Maximum Likelihood Sequence Estimation of Digital Sequence in the Presence of Inter-symbol Interference, IEEE Trans. Inf. Theory. May 1972;
Daoben Li, The statistical theory of signal detection and estimation, Science Press of China (Book), 2004;
Daoben Li, Sequence Detection in the Double-steady Time-varying Channel, Journal on Communications, 1981 (1);
Daoben Li, Analysis for the Characteristic of Error Rate for the Homogeneous Time-varying Inter-symbol Interference Channels, Journal of Beijing University of Posts and Telecommunication, 1987(1);
Daoben Li, A New Error Probability Bound for Inter-symbol Interference Channels, Electronic Journal, 1991(6);
Daoben Li, Error Bounds for Homogeneous Random Time-varying Inter-symbol Interference Channels, 1988 Beijing Int. Workshop on Inf. Theory, June, 1988;
Daoben Li., Minimum Error Probability for Asynchronous Multiple Access Uncorrelated Facing Inter-symbol Interference Channels, 1990 IEEE Symp. On Inf. Theory, San Diego, 1990;
Forney G. D., Lower Bound on the Error Probability in the Presence of Large Inter-symbol Interference, IEEE Trans. Comm. February 1972;
Magee F. R., Proakis J. G., Adaptive Maximum Likelihood Sequence Estimation for Digital Signaling in the Presence of Inter-symbol Interference, IEEE Trans. Inf. Theory. 1973, IT-19, 120-124;
Magee F. R., Proakis J. G., An Estimation of Upper Bound on Error Probability for Maximum Likelihood Sequence Estimation for Channels Having for a Finite-duration Pulse Response, IEEE Trans. Inf. Theory. 1973, IT-19, 699-702;
Wyner A. D., Upper Bound on the Error Probability for Detection with Unbounded Inter-symbol Interference, BSTJ September 1975;
Messerchmitt D. G., A Geometric Theory of Inter-symbol Interference. Part II: Performance of the Maximum Likelihood Detector, BSTJ November 1973;
Seshadri M., Anderson J. B., Asymptotic Error Performance of Modulation Codes in the presence of severe Inter-symbol Interference. IEEE Trans. Inf. Theory, 1974, IT-20, 479-489;
Verdu S., Maximum Likelihood Sequence Detection for Inter-symbol Interference Channels: A New Upper Bound on Error Probability, IEEE Trans. Inf. Theory, January 1987.

The above references have proved that the equalization is not the optimal way to receive signals out of the aforementioned interference. Some people in the references even calculated the boundary of the receiving error probability of this way, but no one has ever pointed out to utilize the coding constraint relation caused by the interference between the symbols to improve the spectral efficiency of the system.

### SUMMARY OF THE INVENTION

Although the present invention also relates to a time division multiplexing technique, the mainly purpose is not on the multi-path digital communication, but to improve the spectral efficiency of the system. For the conventional multiplexing technologies such as Time Division Multiplexing TDM, Frequency Division Multiplexing FDM and Orthogonal Frequency Division Multiplexing OFDM, the merely multiplexing itself cannot improve the spectral efficiency of the system. But in the present invention, multiplexing scheme is used to greatly improve spectral efficiency of the system. In the present invention, there is no need to isolate the symbols each other. Furthermore, there is strong overlapping between them, and so it is called Overlapped Time Division Multiplexing (OvDM). The overlapping of the symbols in the present invention isn't taken as interference but used actively as a new coding constraint relation. The more the overlapping is, the longer the length of the encoding constraint is, the higher the coding gain is and the spectral efficiency is. When in same threshold signal interference ratio, it can provide much higher spectral efficiency than the existing high-dimension modulation techniques. On the other hand, for the same spectrum efficiency, the required threshold signal interference ratio is much lower than the high-dimension modulation techniques, especially in the random time-varying channel. This is because in the present invention the signal symbols of each slot can be broadband signals, allowing selective fading with strong ability of anti-fading itself. No one has ever pointed out to utilize the coding constraint relation caused by the interference between the symbols to improve the spectral efficiency of the system.

One objective of the present invention is to provide a time division multiplexing method to improve the spectral efficiency of the system by multiplexing. The number of the required system levels will not increase with the improvement of spectral efficiency exponentially but only algebraically, thereby the linearity requirement of the system is greatly reduced. In the overlapping time division multiplexing, there is no special requirements for transmission function of the system. Thus it can avoid the use of the complex techniques such as adaptive channel equalization in the system. Compared with other techniques, for the same spectral efficiency, the threshold signal interference ratio of the Overlapped Time Division Multiplexing is much lower in the same working condition, so as to save transmission power and increase the service coverage particularly when operating in the random time-varying channel. In this way, the wider spectrum of the signal multiplexed can be used (including the increase of the bit transmission rate), and the random variation of the channel will automatically generate implicit diversity effect and improve transmission reliability of the system. The wider the spectrum of the multiplexed signal is, the higher the diversity gain and the transmission reliability are.

The present invention provides a method of time division multiplexing by using a number of symbols in the time domain to transmit paralleled data sequences. The aforementioned method includes the following steps: the transmitting terminal generate a number of transmitting signals with the symbols overlapped in the time domain; according to the accurate corresponding relationship between the transmitted data sequence and its time waveform, the receiving end detects the received signals based on data sequence in the time domain.

The transmitting terminal generates a number of transmitting signals with the symbols overlapped in the time domain according to the design parameters.

Determine the design parameters, as set forth above, based on the preset channel parameters and system parameters.

The above-mentioned design parameters includes the number of basic modulation level M, the basic length of the symbol [symbol] , the length of symbol Tₛ, the interval of the symbol ΔTₛ, the multiplicity of the symbol overlapping K and the length of frame T.

The relationship of the multiplicity of the symbol overlapping K, the interval of the symbol ΔT and the length of symbol T is as follows: (K−1)ΔTₛ<Tₛ≦KΔTₛ.

The length of mentioned symbol is Tₛ= [symbol] +Δ, in which [symbol] is the basic length of the symbol, Δ is the maximum value of the time diffusion of the channel.

The length of the mentioned basic symbol is [symbol] Δ, in which Δ is the maximum value of the time diffusion of the channel.

The basic length of the mentioned symbol [symbol] is equal to or less than the maximum value of the time diffusion of the channel Δ.

The interval of the mentioned symbol ΔT is less than the coherent time of the channel [symbol] .

The length of the frame T< [symbol] , in which [symbol] is the coherent time of the channel.

Increase the multiplicity of the symbol overlapping K by reducing the interval of the symbol ΔTₛ.

The above mentioned channel parameters include the maximum value of the time diffusion of the channel Δ or the coherent bandwidth of the channel [symbol] ; and the maximum value of the frequency diffusion of the channel [symbol] or the coherence time of the channel [symbol] .

The above mentioned system parameters include the bandwidth of the system B, the requirements on spectral efficiency and linearity.

The order of the implicit frequency diversity can be increased by improving the bandwidth of the system B, or by interleaving and coding, or improving the bit transmission rate of the system or expanding the spectrum of the signal.

The generation of a number of transmitting signals with the symbols overlapped in the time domain by the mentioned transmitting terminal includes several steps as follows: generate the in-phase and orthogonal envelope waveform of the l=0 path modulation signal envelope waveform; then generate the in-phase and orthogonal envelope waveform of the other modulation signals by the time shift of the in-phase and orthogonal envelope waveform as mentioned above; the modulation signal waveform after data modulation and filtering of each modulation signal is generated by the product of the in-phase and orthogonal envelope waveforms of each referred modulation signal and the in-phase and orthogonal data symbols of each corresponding signal; add all the above mentioned modulation signals, and the transmitting signal is generated.

According to the one-to-one relationship between the transmitted data sequence and the time waveform of the transmitted data sequence, the receiver detects the received signals based on data sequence in the time domain. The steps of the detection is as follows: generating the received digital signal sequence for the received signals in each frame, detecting the received digital signal sequences as mentioned above, so as to obtain the modulation decision in the above mentioned frame of the modulation data of all symbols.

The steps of the generation of the received digital signal sequence for the received signals in each frame as mentioned above are as follows: generate the symbol time synchronization of the received signals in the receiving end; process the digitization to the signals in each frame according to sampling theorem.

The above mentioned digitization is done in the intermediate frequency or in the baseband.

Detection of the sequence is based on the maximum likelihood sequence detection when the probabilities of all sequences are the same, and it is the maximum posteriori probability sequence detection when the probabilities of the sequences are not the same.

The sequence detection of the received digital signal sequences for the received signals includes the following steps: modeling the complex convolution coding to the overlapping time division multiplexing system; listing all the states of the overlapping time division multiplexing system; making the trellis diagram of the overlapping time division multiplexing system, and listing all the coding output of each branch; preparing two memories for each stable state; searching the optimal path which has the minimal Euclidean distance or weighted Euclidean distance with the received digital signal sequence from the trellis diagram above, and finally the data sequence corresponding to this path is the output for the final decision.

The modeling of the complex convolution coding to the overlapping time division multiplexing system as mentioned above includes the following steps: measure the actual channel, and find out the estimation of the received signal complex envelope in different time interval of the symbols; generate the tap coefficients of the channel model in the overlapping time-division multiplexing system by the estimation of the received signal complex as mentioned above.

The measurement of the practical channel to find out the estimation of the received signal complex envelope in different time interval of the symbols as mentioned above makes use of the dedicated pilot signal measurement; or calculate the estimated value through the calculation of the received signals by using the decision information; or take the combination of both; or calculate the estimated value by the blind estimation.

All the states of the overlapping time division multiplexing system include the initial state, pre-transition state, stable state, post-transition state and final state.

The reserved path memory of the two memories prepared for each stable state is used to store the reserved path reaching the above-mentioned state; the Euclidean distance or weighted Euclidean distance memory is used to store the Euclidean distance or weighted Euclidean distance between the reserved path reaching the state and the received digital signal sequence.

The above mentioned transition state can use any memory of the stable states.

Searching the optimal path which has the minimal Euclidean distance or weighted Euclidean distance with the received digital signal sequence from the trellis diagram above has the following steps: step 1, let the path Euclidean distance or weighted path Euclidean distance of the initial node (l=0) state be zero; step 2, calculate all states S of the node l (l=1, . . . , L−K+1), and calculate the path Euclidean distance or weighted Euclidean distance between the coding signals of all the branches which comes from the former states to the states S and the received digital signals; step 3, for each state S, add the Euclidean distance or weighted Euclidean distance of the branches arriving at this state to the Euclidean distance or weighted Euclidean distance of the branches starting from this state, and a new or several new Euclidean distance or weighted Euclidean distance of branch will be generated; If there is several new path Euclidean distance or weighted path Euclidean distance, choose the minimum one as the path Euclidean distance or weighted path Euclidean distance of the state of node l; update and store it into the Euclidean distance or weighted Euclidean distance memory of the state S. Step 4, for the node l, find out the reserved path corresponding to the path Euclidean distance or weighted path Euclidean distance of each state S, update and store it into the reserved path memory of this state of S; step 5, repeat step 1 to step 4 to the next node, until the node L+K−2 is reached, and there is only one reserved path remaining, then the data sequence corresponding to this reserved path is the output for the final decision.

By searching the reserved path memory of each state at any time, once there is initial part of the same in the reserved path, then the initial part of the same is seen as the decision output.

If there is still no decision output when the reserved path memory is full, then make decision compulsively, meaning that, the initial bit with minimum distance is seen as the decision output.

If there is still no decision output when the reserved path memory is full, then make decision according to the majority logic decision, namely, the majority of the initial bits of all the reserved paths is seen as the decision output.

The above-mentioned path Euclidean distance or weighted path Euclidean distance memory is only used to store the relative distance, namely, when let the minimum or maximal path Euclidean distance or weighted path Euclidean distance is zero, the path Euclidean distance or weighted path Euclidean distance memory of the other states is only used to store the relative distance which is the differentials of the Euclidean distance or the weighted Euclidean distance with the minimum or maximal distance. The sequence detection as mentioned above is the maximum likelihood sequence detection.

The present invention also provides a time division multiplexing system which includes the transmitter and receiver. The transmitters include the overlapping time division multiplexing modulation unit used to generate the transmitted signals overlapping in the time domain of a number of symbols; transmitting unit used to transmit the transmitted signals to the receiver. The receiver includes the receiving unit used to receive the transmitted signals from the transmitting unit; sequence detection unit used to do the data sequence detection for the received signals in the time domain.

Modulation unit of the overlapping time division multiplexing includes digital waveform generator used to generate the in-phase and orthogonal waveform of the wave envelope of the first modulation signal digitally; shift register used to do time shift of the in-phase and orthogonal waveform of the wave envelope of the first modulation signal generated by the digital waveform generator so as to obtain the in-phase and orthogonal envelope waveform of other modulation signals; serial-parallel converter used to convert the data sequence input serially into the parallel in-phase and orthogonal data signals of the corresponding modulation signals; multiplier used to multiply the in-phase and orthogonal data signal output by the serial-parallel converter with the in-phase and orthogonal envelope waveform of the corresponding modulation signal to obtain the modulation signal waveform of each modulation signal after data modulation filtering; adder used to add all the modulation signal waveform of each modulation signal after data modulation filtering which is the output by the multiplier to generate the transmitted signal.

The transmitter can also include spread-spectrum unit used to increase the total bandwidth of the system if necessary.

The transmitter can also include the interleaving unit and encoding unit, if necessary, used to increase the order of implicit frequency or time diversity of the system, if necessary, to improve transmission reliability of the system.

The receiver can also include the pre-processing unit which is used to generate the complete synchronous receiving digital signal sequences in each frame.

The above preprocessing unit includes: synchronization unit used to keep the symbol time synchronized for the received signals in the receiver; pilot frequency unit used to measure the channel parameters; digitalization unit used to do digitization for the received signals in each frame.

The sequence detection unit as mentioned above includes: analysis unit memory which is used to work out the convolution coding model and the trellis diagram of the overlapping time division multiplexing system, list all the states of the overlapping time division multiplexing system, and store them; comparators which is used to analyze the trellis in the diagram analysis unit memory, and search the path which has the minimum Euclidean distance or weighted Euclidean distance with the received digital signals; the memory for the reserved path of the steady state S, which is used to store Euclidean distance or weighted Euclidean distance between the reserved path reaching the steady state S and the received digital signal sequence where the steady state S is any of all the steady states mentioned above.

There is a reserved path memory and a Euclidean distance or weighted Euclidean distance memory for each state, and the transition state can borrow any one of the steady state memories.

The length of reserved path memory as mentioned above is 4×K (4K) to 5×K (5K), in which K is the number of overlapping.

The length of reserved path memory as mentioned above is shorter than 4K or longer than 5K, in which K is the number of overlapping.

The Euclidean distance or weighted Euclidean distance memory as mentioned above only stores the relative distance.

The most benefits of the present invention is to provide a new type of theoretical concepts and related techniques which greatly improves the spectral efficiency of the system by using time division multiplexing. It does not need to do any pre-processing to the transmission function of the channel, and the capacity of the channel will not be reduced. On the contrary, the actual capacity of the system will be closer to the theoretical channel capacity. In short, the present invention provides a time division multiplexing technique which is effective, reliable, practical and it greatly improves the spectral efficiency of communication systems.

### BRIEF DESCRIPTION OF THE DRAWINGS

For the full understanding of the nature of the present invention, reference should be made to the following detailed descriptions with the accompanying drawings in which:

FIG. 1: The traditional time division multiplexing;

FIG. 2: The overlapping time division multiplexing;

FIG. 3: The general illustration of overlapping time division multiplexing;

FIG. 4: The received signal diagram of the overlapping time division multiplexing system when K=3;

FIG. 5: The time varying complex convolution coding model of the overlapping time division multiplexing system;

FIG. 6: The tap coefficient of the shift register channel model in the overlapping time division multiplexing system;

FIG. 7: The tree diagram of the input-output relationship of the overlapping time division multiplexing system when K=3;

FIG. 8: The state transition diagram of the node;

FIG. 9A: The first half of the Trellis diagram when K=3;

FIG. 9B: The second half of the Trellis diagram when K=3;

FIG. 10: The state diagram of the overlapping time division multiplexing system when K=3;

FIG. 11: The detection process of the maximum likelihood sequence detection (MLSD) algorithm;

FIG. 12: The transmitter block diagram of the overlapping time division multiplexing system;

FIG. 13: The block diagram of the time division multiplexing system in the present invention;

FIG. 14: The block diagram of the overlapping time division multiplexing modulation unit of the transmitter in the present invention;

FIG. 15: Another design block diagram of the transmitter in the present invention;

FIG. 16: The block diagram of the pre-processing unit of the receiver in the present invention;

FIG. 17: The block diagram of the sequence detection unit of the receiver in the present invention.

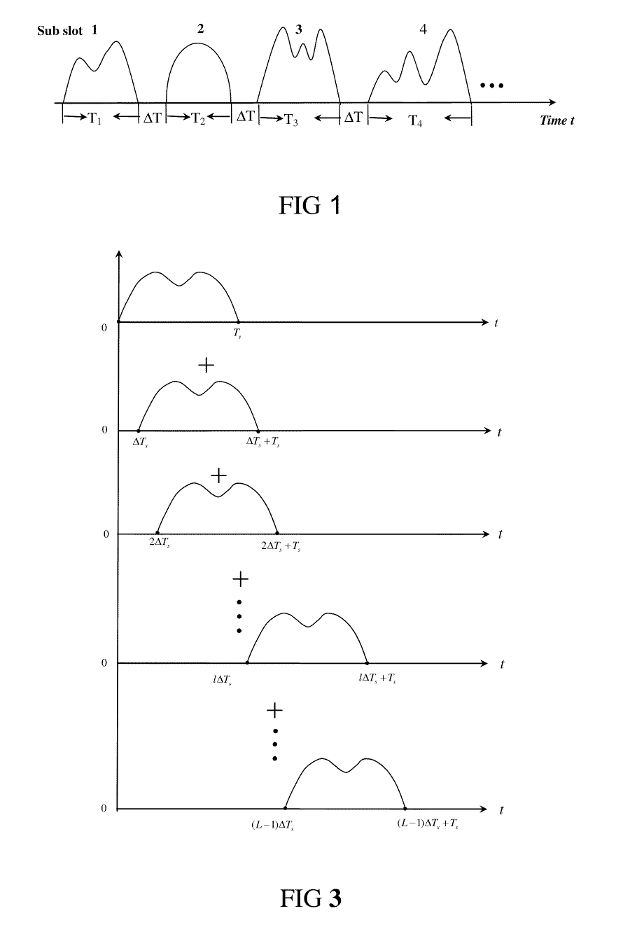

Like reference numerals refer to like parts throughout the several views of the drawings.

### DESCRIPTION OF THE PREFERRED EMBODIMENT

The basic principle, mathematical description, maximum likelihood sequence (MLSD) detection (because the maximum posteriori probability detection is only weighting on the sequences with different priori probability and there is no essential difference with MLSD) and the specific implementation of the present invention will be explained explicitly with the diagrams as follows.

Firstly, we explain the basic principle of the present invention.

To simplify the explanation, the space channel will not be considered in this description. As we all know that the traditional time division multiplexing (TDM) requires that the multiplexed signal symbols should be isolated completely with each other in the time domain, to make sure that there is no interference among them, and the multiplexed signals can utilize any ways of communication and modulation independently.

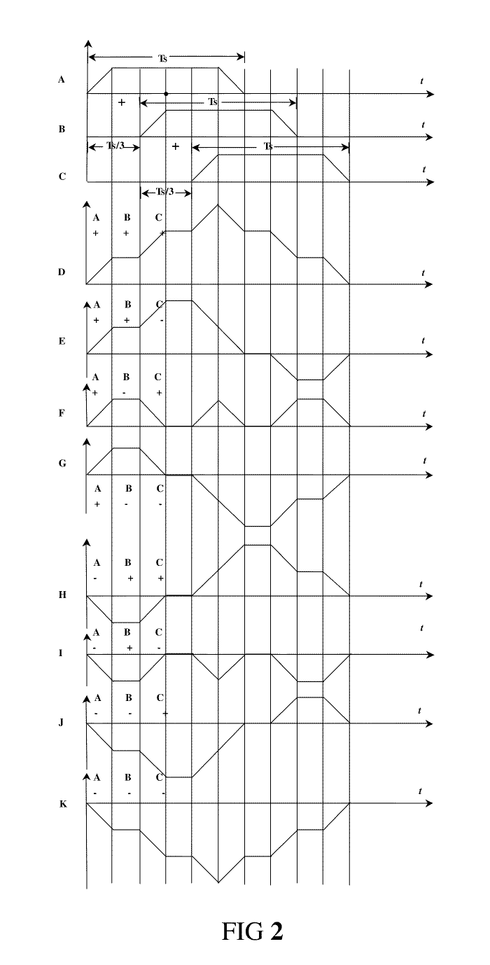

It is clear that if the multiplexed signal symbols cover and overlap with each other in time domain, the spectral efficiency of the system can be improved further. But it is generally believed that there will be serious interference mutually between the adjacent multiplexed signal symbols, as shown in FIG. 2, the three symbols in this figure has overlapped together in time domain. As a result of the overlapping of the symbols, the demodulation for any symbol by traditional way will be interfered seriously by other adjacent symbols, so it is absolutely impossible to demodulate it by traditional way. However, by re-examining FIG. 2, and assuming the width of the three multiplexed signals A, B, C Ts seconds, the interval between them, namely relatively time-lapse is

$$\frac{{T}_{s}}{3} seconds ,$$

which means the symbols of the three signals overlap together completely.

To simplify it, we assume the shape of the symbols of the three multiplexed signals A, B, C is exactly the same, the phase characteristics are zero, both in binary positive and negative modulation, the length of the symbols is Ts seconds, the modulation bandwidth of each signal is B0 Hz, namely B0 Hz after overlapping, but the time duration of the symbols is changed into

$$\frac{5 {T}_{s}}{3}$$

and the three signals synchronize fully. Because the symbols overlap together, and all interfered by other adjacent symbols, so it is absolutely impossible to demodulate them by conventional solution. However, in the present invention the three symbols are processed together rather than separately. Then the situation is completely different, because in a 5Tₛ/3 time period, the data transmitted by the symbols A, B, C is limited to no more than the eight cases listed in Table 1:

TABLE 1

| Serial | Date group | | | Waveform |
|---|---|---|---|---|
| number | A | B | C | sharp |
| 1 | + | + | + | D |
| 2 | + | + | − | E |
| 3 | + | − | + | F |
| 4 | + | − | − | G |
| 5 | − | + | + | H |
| 6 | − | + | − | I |
| 7 | − | − | + | J |
| 8 | − | − | − | K |

The corresponding received signals are respectively D, E, F, G, H, I, J, K in FIG. 2 when the noise is not considered, and the data corresponds to the waveform one-to-one. Similarly, for any other number of overlapping, it can be tested and also be proved in mathematics at the same time that the data groups and the waveform can correspond one-to-one. In normal case, if the width of the multiplexed signal symbols is Ts seconds, wherein Ts should include all the time spread factors in the system (such as timing drift of the system, multipath spread, etc.), the mutual time shift or the interval of symbols is ΔTₛ seconds when the overlapping time division multiplexing is utilized, and further satisfy:

(K−1)ΔTₛ<Tₛ≦KΔTₛ; K=1, 2, . . . .

There are K adjacent symbols overlapping together with each symbol transmitting information with the dimension of M=2^{Q}, namely, each symbol carries Q=log₂ M bits information, if there are L overlapping symbols of this kind, then there are 2^{QL}=M^{L} possible groups of the transmitted data finally, and 2^{QL}=M^{L} kinds of corresponding waveform. So it only needs to find out which waveform the transmitted data group belongs to in the receiving end. Although the time overlapping between symbols damage the waveform of the single transmitted data symbol itself and the correspondence relationship between the single transmitted data symbol and its time waveform, the correspondence relationship between the total transmitted data symbol sequence and its waveform is not damaged. This is the important theoretical basis on which the present invention is based. Of course, when M^{L} is great, how to reduce the complexity of the system is a very important practical issue. The present invention provides an optimal algorithm to solve the above problem, the complexity only depends on M^{K} but M^{L}.

FIG. 3 is the general case, wherein the spectrum width of the multiplexed signal symbols is B0 Hz, all the symbol width is Tₛ seconds, the number of modulation level is M=2^{Q}, namely, each symbol carries Q bits. As a comparison, the bit rate is Q/Tₛ bps when the overlapping time division multiplexing is not used and the spectral efficiency is

$$\frac{Q}{{B}_{0} {T}_{s}} bps \text{/} Hz .$$

The bandwidth of the system with L overlapped symbols is still B₀ Hz, but the total length of the symbol is changed into Tₛ+(L−1)ΔTₛ, seconds, wherein L symbols carry LQ bits in all, so the total bit transmission rate will be improved to

$$\frac{LQ}{{T}_{s} + ( L - 1 ) Δ {T}_{s}}$$

bps at the same time, and the spectral efficiency is as follows:

$$\frac{LQ}{{B}_{0} {T}_{s} + {B}_{0} ( L - 1 ) Δ {T}_{s}} \leq \frac{LQ}{{B}_{0} {T}_{s} ( 1 + \frac{L - 1}{K} )} = \frac{LKQ}{{B}_{0} {T}_{s} ( K + L - 1 )} {\to }^{L K} \frac{KQ}{{B}_{0} {T}_{s}}$$

$$And$$

$$\frac{LQ}{{B}_{0} {T}_{s} + {B}_{0} ( L - 1 ) Δ {T}_{s}} > \frac{LQ}{{B}_{0} {T}_{s} ( 1 + \frac{L - 1}{K - 1} )} = \frac{L ( K - 1 ) Q}{{B}_{0} {T}_{s} ( K - 1 + L - 1 )} {\to }^{L K} \frac{( K - 1 ) Q}{{B}_{0} {T}_{s}}$$

We can see that the total number of the overlapped symbols L K, wherein, when L is large enough, the spectral efficiency of the system will increased by K (the number of overlapped symbols at the same time) times. The larger K is, the higher the spectrum efficiency of the system is. We found that the spectral efficiency of the system improves proportionally with the increase of the number of the overlapped symbols K, but the number of the levels in the system doesn't increase exponentially (Instead, it increases algebraically). As did in the high-dimension modulation. For example, when Q=1, namely, each sub-carrier using binary modulation, the number of the overlapping system level of the K symbols is K+1, it only grows with K linearly. When Q=2, namely, each sub-carrier using M=2²=4 modulation, the number of the overlapping in-phase I channel level of the K symbols is K+1, the number of the level of orthogonal Q channel is also K+1, the total number of the I system level is (K+1)² which only increases with K squarely. Obviously when the number of the distinguishable level of the channel is fixed, the spectral efficiency by using overlapping time division multiplexing system is higher than that of high-dimension (multi-level) transmission system. For example, 64QAM modulation can be used for the wireless communication system in the condition of high-speed mobile. The number of the system level is M=64, and the number of the level of the in-phase I and orthogonal Q channel are both \sqrt{M}=\sqrt{64}=8. Given the number of overlapping K=7 of the QPSK overlapping time division multiplexing (OvDM) system with number of the level of I, Q channel, each symbol in OvDM can carry 14 bits. But for traditional 64QAM system, it can only carry 6 bits for each symbol, so its spectral efficiency is only 3/7 of overlapping time division multiplexing system. Generally speaking, if the original system can support the M-QAM modulation, for the same number of the system level, the multiplicity of the overlapping by using QPSK modulation for overlapping time division multiplexing system is K=\sqrt{M}−1, and the spectral efficiency will be improved by

$$\frac{2 ( \sqrt{M} - 1 )}{{log}_{2} M}$$

times than that in the M-QAM modulation system.

After the introduction of the basic principle, the following is the mathematical description of overlapping time division multiplexing.

In general, we assume that the information source is equiprobable and memoryless, the symbol duration is Ts seconds after transmission in the channel, the transmitted information is transmitted parallel in the time domain, there are totally L overlapping symbols for each frame in the system, and the bandwidth of each symbol is B0 Hz after the modulation filtering and channel broadening. To simplify the analysis, we further assume that the modulation mode and the complex envelope characteristics symbols of the filter of each symbol are exactly the same, and there are K symbols overlapping with each other during the width of basic symbol Ts seconds.

Its transmitted complex data sequence is as follows:

ũ=[ũ₀, ũ₁, . . . , ũₙ, . . . , ũ_{L-1}];

Where ũₗ Iₗ+jQₗ; l=0, 1, 2, . . . , L−1;

Iₗ, Qₗ is the transmitted data signal level symbols in the in-phase I and orthogonal Q channel in the l symbol interval, wherein t∈[lTₛ,(l+1)Tₛ].

The complex envelope of the transmitted signal (the complex carrier frequency exp j2πfₒt is not included) is as follows:

$$\sqrt{2 {E}_{0}} {\sum }_{l = 0}^{L - 1} {\tilde{u}}_{l} {a}_{0} ( t - l Δ {T}_{s} ) \qquad ( 3 )$$

which ã₀(t)=0, t∉[0,Tₛ];

∫₀^{T}^{ₛ}|ã₀(t)|²dt=1

ã₀(t)ã₀(t) is the normalized transmitted complex modulation signal envelope, and the bandwidth of it's complex frequency spectrum Ã(f) is B₀;

Ã(f)=0, f∉(−B₀/2, B₀/2);

f₀ is the carrier frequency: f₀>B₀/2, At the same time f₀Tₛ 1 or it is a positive integer;

ΔTₛ is the relative time shift (the interval between the symbols) which satisfies the following relationship:

(K−1)ΔTₛ<Tₛ≦KΔTₛ;

The symbol duration Tₛ should include the factors such as the time spread of the channel;

E₀ is the energy of the transmitted signal of each symbol;

The bandwidth of the system is still B0, but the length of the frame (the total length of the overlapped symbols) is:

T=Tₛ+(L−1)ΔTₛ,

The number of ΔTₛ is L+K−1 (not L) in the frame length.

In the present invention the influence caused by the time spread (multi-path broaden) is processed together. We assume that the symbol duration is Ts second after the time spread of the channel, then the complex of the received signal is:

$$V ( t ) = \frac{1}{2} \sqrt{2 {E}_{s}} {\sum }_{l = 0}^{L - 1} {u}_{l} {a}_{l} ( t - l Δ {T}_{s} ) + \tilde{n} ( t ) = \tilde{s} ( t ) + \tilde{n} ( t )$$

where ñ(t) is the complex envelope of the white Gaussian noise, and its power spectral density is N₀ W/Hz. Eₛ is the energy of the received symbol, Eₛ=αE₀, α is the channel fading;

The duration of ãₗ(t−lΔTₛ) is [lΔTₛ,lΔTₛ+Tₛ], wherein

ãₗ(t−lΔTₛ)=0, t∉(lΔTₛ,lΔTₛ+Tₛ),

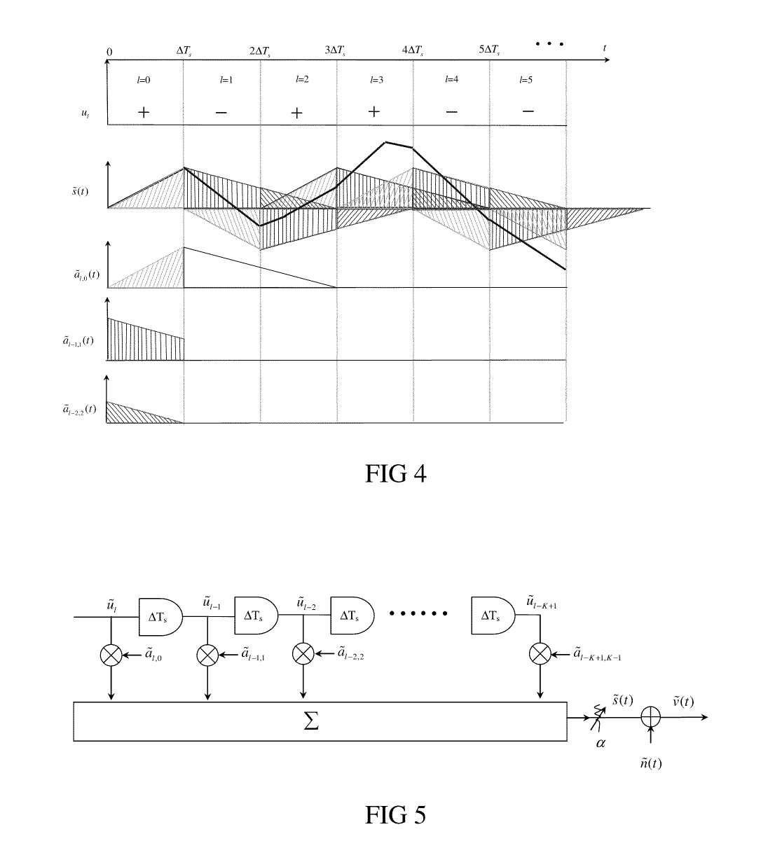

The FIG. 4 is the received signal of the overlapping time division multiplexing when K=3.

As for random time-varying channel, when the l is different, the complex envelope of the received signals may be different, so the possibility is shown here by the subscript l. If the channel is not random time-varying or it is random time-varying but the change is very slow (so it is considered to be non-random time-varying in a frame length T), then the cases of the subscript l can be omitted. But generally speaking, the complex envelope of the received signals may be different with that of the transmitted signals. We can see that the inter-symbol interference only appear among the adjacent K symbols. In general, except the first and the final (K−1) ΔTₛ, the received signals at other time are the overlapping K symbols. Especially at the time tε[lΔTₛ,(l+1)ΔTₛ], l=0, 1, . . . , L−K+1, the complex of the received signal is as follows:

\tilde{v}ₗ(t)=\tilde{s}ₗ(t)+ñₗ(t) t∈[lΔTₛ,(l+1)ΔTₛ] (5)

wherein:

•ₗ(t)=•(t)×[u(t−lΔTₛ)−u(t−(l+1)ΔTₛ)] l=0, 1, 2, . . . , L+K−1; wherein, • is the operation which satisfies this expression.

$${\tilde{s}}_{l} ( t ) = \frac{1}{2} \sqrt{2 {E}_{s}} {\sum }_{k = 0}^{Min ( l , K - 1 )} {\tilde{u}}_{l - k} {\tilde{a}}_{l - k , k} ( t ) ; \qquad ( 6 )$$

wherein:

$${\tilde{a}}_{l - k , k} ( t ) = {\tilde{a}}_{l - k} ( t + ( l - k ) {T}_{s} ) \times [ u ( t - k Δ {T}_{s} ) - u ( t - ( k + 1 ) Δ {T}_{s} ) ] \\ l = 0 , 1 , 2 , … , L - K + 1 ; k = 0 , 1 , … , K - 1 ; \\ u ( t ) = \{ \begin{matrix}1 & t > 0 \\ \frac{1}{2} & t = 0 \\ 0 & t < 0\end{matrix} \qquad ( 7 )$$

u(t) is the unit step function in the time domain.

Here, the scope of l is different from that before, and is greater by K−1 compared to L. This is because in system frame size T, the number of ΔTₛ, is bigger than L by K−1. But we should note that, when l>L−1

ũₗ=0; and ãₗ(t)=0;

As shown in FIG. 5, this is the time-variable complex convolution encoding model of the overlapping time division multiplexing system.

The remaining question is the maximum likelihood sequence detection MLSD algorithm utilized in the present invention in order to solve the data sequence u. Let's make the following expression minimum in time T, when tε[0,T], T=(L+K−1)ΔTₛ:

$${Min}_{u} {\int }_{T} {‖ v ( t ) - \tilde{s} ( t ) ‖}^{2} d t \qquad ( 9 )$$

where: ∥•∥² is the square modulus of •.

The physical meaning of formula (9) is that during the time t∈[0,(L−1)ΔTₛ+Tₛ], i.e. in a length of frame, we try to find out the most possible data sequence U to ensure its time waveform corresponding \tilde{S}(t) most close to the received signal waveform \tilde{v}(t) (the smallest Euclidean distance). The optimal sequence detection MLSD algorithm will be introduced later, and other fast quasi-optimal algorithm will be disclosed in another patent of the same inventor.

Then, we analyze the tap coefficient of the shift register channel model in the overlapping time-division multiplexing system:

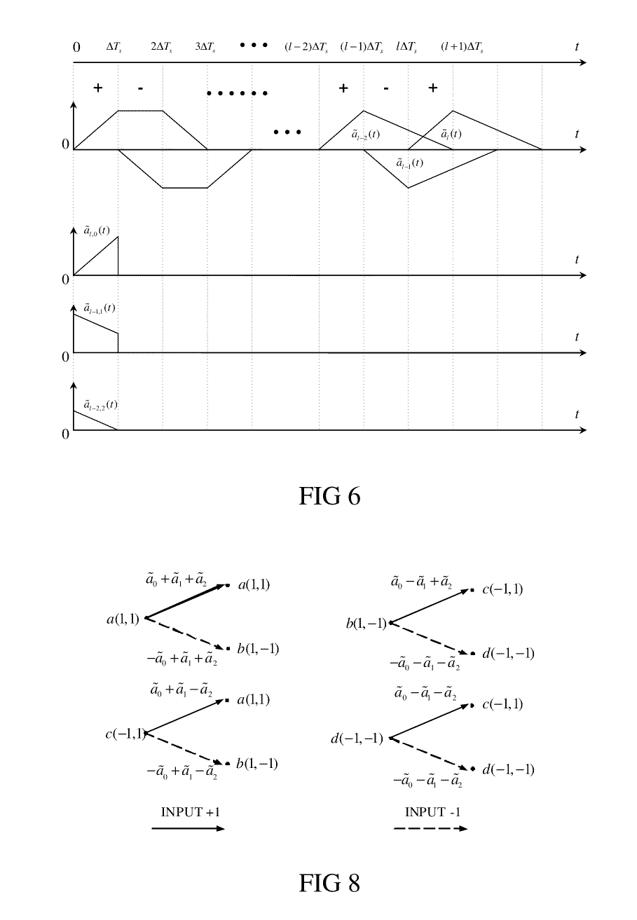

As we all know, in the random time-varying channel, the impulse response function of channel \tilde{h}(t,∈) changes randomly with the observation time, so the shape of the complex envelope of the received signal changes in general (in FIG. 6). In t∈(lΔTₛ,(l+1)ΔTₛ), the value of tap coefficients for each channel are shown in FIG. 6, especially when the coherence time of the channel is greatly longer than the length of symbols, namely, [symbol] Tₛ, the tap coefficients will be tightened into some kind of sample (value), which simplifies the engineering of the system implementation.

The tree diagram of the overlapping time division multiplexing systems is described as follows:

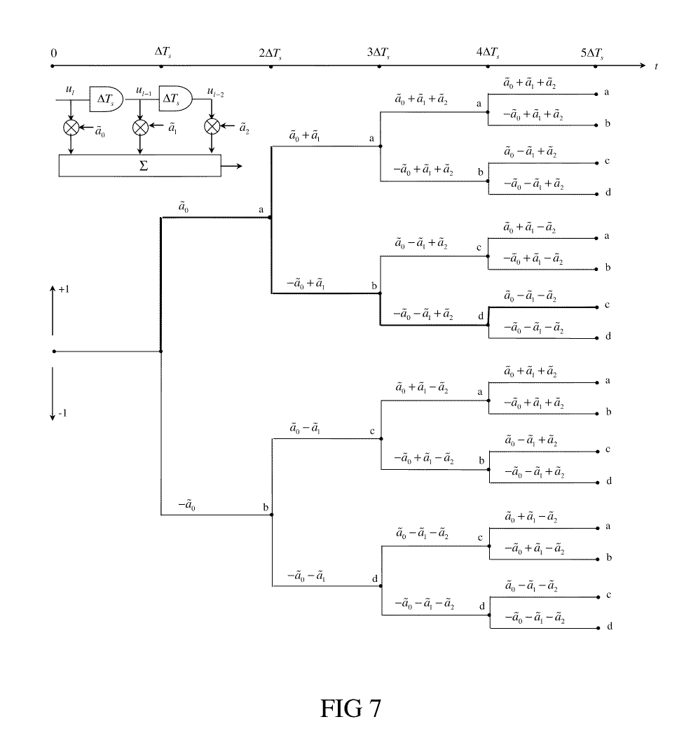

The tree diagram of the overlapping time division multiplexing systems is a vivid duplication to represent the input-output relationship of the overlapping time division multiplexing system. FIG. 7 is a input-output diagram of Q=1 which is binary overlapping time-division multiplexing system when K=3. We use the upward branch to express the input bit of uₙ=1, and the downward branch to express the input bit of uₙ=−1, and the corresponding coding output is shown at the top of the branches. The bold line path represents the input sequence u=[1, −1, −1, 1, . . . ]^{T} in the diagram, and the corresponding output waveform of the complex convolution coding are ãa_{0,0}(t), −ã_{1,0}(t)+ã_{0,1}(t), −ã_{2,0}(t)−ã_{1,1}(t)+ã_{0,2}(t), ã_{3,0}(t)−ã_{2,1}(t)−ã_{1,2}(t). When studying the diagram carefully, we can find that it is one-to-one correspondence between the input and output sequence. There is no input sequence corresponds with two or more of the output sequences corresponding, and it is also true on the contrary. Therefore symbol overlapping does not destroy the one-to-one corresponding relationship between the input and output sequence in the time domain. So if the detection is based on sequence in the time domain, the non-reduceable error probability is impossible to happen. Of course, the traditional detection method based on symbol must be abandoned. If the sequence length is fixed, such as length L, for the binary information source with the dimension of Q, the total number of possible sequences is 2^{QL}=M^{L}. Then our problems will be reduced to the signal detection with the dimension 2^{QL}=M^{L}. In Communication system, it is usually assumed that the probabilities of the sequences are the same, so the maximum likelihood detection criteria can be used. When the probabilities of the sequences are not the same, maximum posteriori probability criterion should be used (the sequence with large probability multiplied by the greater weight, and vice verse). In this way, it seems that the optimal signal detection problem of the overlapping time division multiplexing system has been solved. It may be true in theory, but difficult to realize in real system, because L is usually large and it is very complicated to use maximum likelihood or maximum posteriori probability criterion directly. Fortunately, the decoding algorithm for convolution codes when the probability of the input sequence are the same has been studied for decades, and the overlapping time division multiplexing system can also be seen as a complex convolution encoder, and so many decoding algorithms of convolution codes, such as Fano algorithm used to search for the optimal (that is, maximum-likelihood function value) path in the tree diagram and the stack (Stack) algorithm as well as the BCJR algorithm, can be used in the signal detection of the overlapping time division multiplexing system after necessary transformation. As these algorithms are not really the optimal maximum likelihood algorithm, they can only be described as quasi-maximum likelihood algorithm, and will not be introduced in the present invention. Now we will disclose another algorithm—maximum likelihood sequence algorithm (MLSD). This is the real maximum likelihood algorithm which comes from the Viterbi algorithm of the convolution codes. For more details, we need to introduce first the Trellis diagram and state (State) diagram of the overlapping time division multiplexing systems.

The Trellis diagram and state diagram of the overlapping time division multiplexing system are introduced as follows:

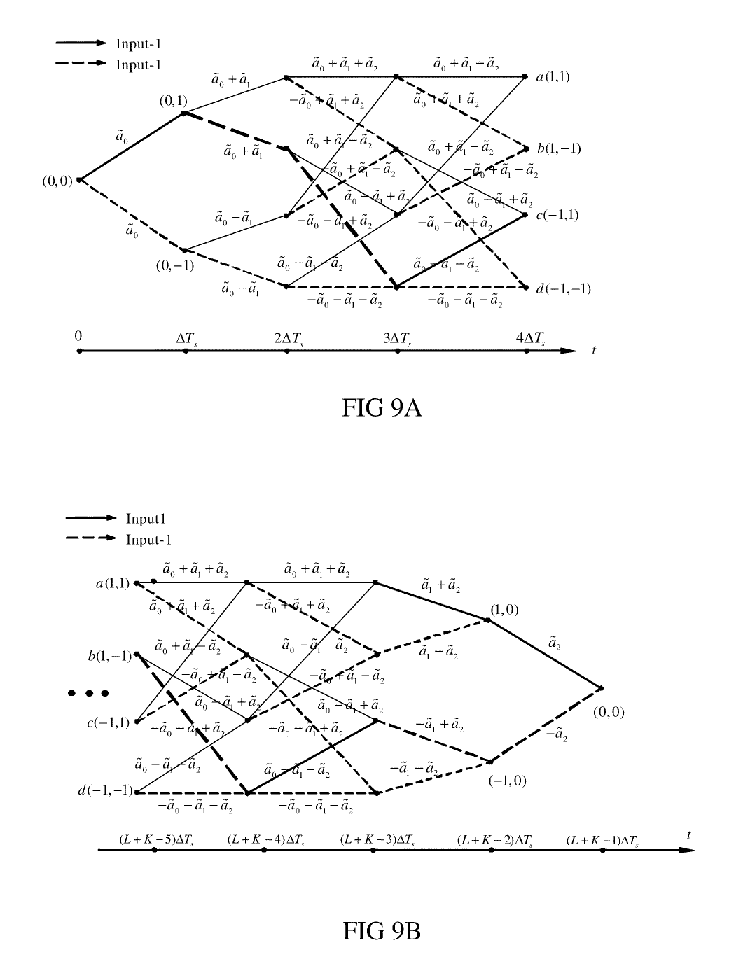

Although the tree diagram can vividly describe the input and output relations, but this diagram is not good, especially because it will expand exponentially when L increases and so it should be simplified. Let us return to FIG. 7, after careful observation we can find that tree is repetitive from the third branch, because all the branches from the nodes marked a have the same output, and the conclusion is also true to the nodes b, c, d. It may be nothing more than the probabilities as follows (in FIG. 8). As it can be seen in the figure that the node a can only be transferred to (input+1) node a and (input−1) node b, while node b only to (input+1) c and (input−1) d, c only to (input+1) a and (input−1) b, d only to (input+1) c and (input−1) d. The reasons for such a phenomenon is very simple, because only K adjacent (specific to this case is 3) symbols interfere with each other. Therefore, when the K bit data is inputted to the channel, the first bit has been shifted out of the rightmost shift unit. So the output of the channel only depends on the former K−1 input data regardless the present data input. In general, for M=2^{Q}, which is Q-dimension binary data input, as long as the former K−1 Q-dimension binary data remain the same, the corresponding output is also the same. Thus in FIG. 7 (Q=1), after the third slip, all the nodes marked a can be merged together, and the nodes b, c and d can also be merged, thus forming a fold of the tree—Trellis diagram. It also can be called as Grid or fence diagram (in FIG. 9A and FIG. 9B) by some researchers. In the figure, provided that the slip of input+1 is shown as real line, and input−1 as dash line. This is because after the merger, we can no longer define the input+1 as the upward branch, and the input−1 as downward branch.

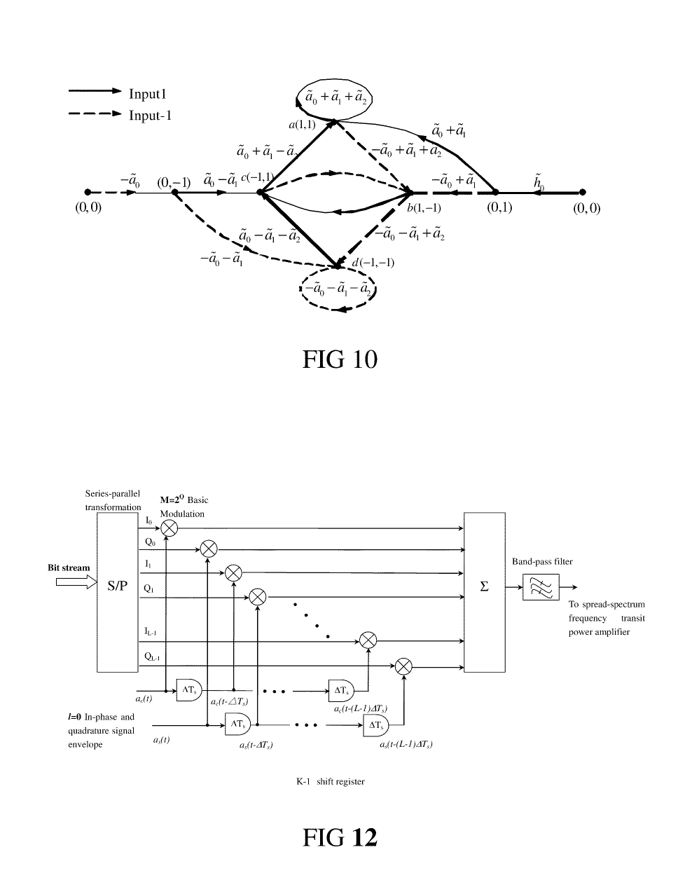

If removing the duplication structure in timeline of the Trellis diagram, we can get a further simplified diagram—state diagram (State Diagram) as shown in FIG. 10. For simplicity, the final and backward transition state are not shown. The states of the state diagram are drawn based on the nodes of the Trellis diagram, i.e., each state is determined by the Q-dimension binary data bit of the former K−1 bits saved by the channel. Therefore, to the overlapping time division multiplexing system with the memory (constraint) length of K, the number of its stable states with the binary input is 2^{K-1}, and 2^{Q(K-1)}=M^{K-1} with Q-dimension binary input. There are also initial, final, former and latter transition state. In this case both the initial and final state are (0,0); the former transition state is (0,−1) and (0,1); the latter transition state is (1,0) and (−1,0). The state transfer relationship of the initial and transition state is very simple except that the initial and final state must be the empty state of zero. But for the former transition state, only if there is zero in the data stored originally in the channel, there is Q-dimension binary + or − data in the new data, so they can only be transferred from one state, and to other 2^{Q}=M states. For the latter transition state, different from the former transition state, only if the data stored originally in the channel is Q-dimension binary + or − data, there is zero of the new input, so they can be transferred from 2^{Q}=M states and only to one state. Please note that in this case, Q=1, K=3. When we write state a(1,1), b(1,−1), c(−1,1), d(−1,−1), the relationship of the information bits is from left to right (for example, in the state b(1,−1), 1 is the first bit entering the channel). But in FIG. 6 of the Q=1 channel model, the first bit entering the channel is stored in the rightmost shift unit, and the time is from right to left.

We can see that the overlapping time division multiplexing system is a finite state machine, whose directed state diagram can completely describe the relationship between input and output of the channel. Because each state represents the former K−1 Q-dimension binary information bits stored in the channel, i.e., (K−1) Q bits, and the transfer branches between the states represent the present input information bits. For example when K=3; the input data bits are . . . , −1, 1, 1, . . . for the Q=1 binary-channel. In the state diagram it is transferred from state c to state a, for c=(−1,1) after another input 1, the −1 originally stored in the rightmost shift is shifted out of the channel, and the new input 1 enter the channel, the state transferred to a=(1,1) and the output of the channel is . . . , ã₀+ã₁−ã₂, . . . , which means that it is the transfer branch from c to a.

Generally, there are 2^{Q(K-1)}=M^{K-1} stable states for the Q-dimension binary input channel with the memory (constraint) length of K, and each stable state can transfer to the other 2^{Q} states, and from the other 2^{Q} stable states. In the Trellis diagram, the above conclusion can be described as follows: there are 2^{Q(K-1)}=M^{K-1} nodes in the Q-dimension binary input channel with the memory (constraint) length of K. In stable condition, there are 2^{Q}=M branches from each node, and 2^{Q}=M branches merging to this node at the same time.

Trellis diagram is very useful in studying the maximum likelihood sequence MLSD algorithm.

After the introduction of the mathematical description of Overlapped Time Division Multiplexing, the following is the maximum likelihood sequence detection called MLSD algorithm.

The maximum likelihood sequence decoding algorithm of convolution codes can be changed and transplanted to detect the signal of the Overlapped Time Division Multiplexing system. Now we still take the binary signal as an example to introduce MLSD algorithm specifically. We know that to the Q-dimension binary input sequence with the length of L, the possible number of output sequences (the possible paths in Trellis or a state diagram) is 2^{QL}=M^{L}. But it will become very complicated to apply the maximum likelihood detection directly because L is usually very large. The essence of MLSD algorithm is its maximum likelihood algorithm, but its complexity has an exponential growth with only the memory length K−1 of the channel, rather than L, so we assume that channel noise is white noise. However, the input data sequence with maximum likelihood function value in the white noise channel should be the input sequence corresponding to the path with the minimum Euclidean distance with the receive signals in Trellis diagram or tree diagram, namely, to choose the optimal \tilde{s}(t), which satisfies

$${Min}_{u} {\int }_{T} {‖ \tilde{V} ( t ) - \tilde{S} ( t ) ‖}^{2} d t ,$$

Where, T is the entire time to receive signals.

But we do not need to calculate the likelihood function or the Euclidean distance of the entire path length as a result of the cyclical merger of the paths in Trellis diagram. Because when the paths are merged, those paths with relatively large Euclidean distance before the merger can be got rid of completely. For example, when t=3ΔT there are two paths overlapped for the first time at the node a in FIG. 9. They are:

á₀, á₀+á₁, á₀+á₁+á₂ (corresponding to input sequence 1, 1, 1)

and −á₀, á₀−á₁. á₀+á₁−á₂ (corresponding to input sequence −1, 1, 1).

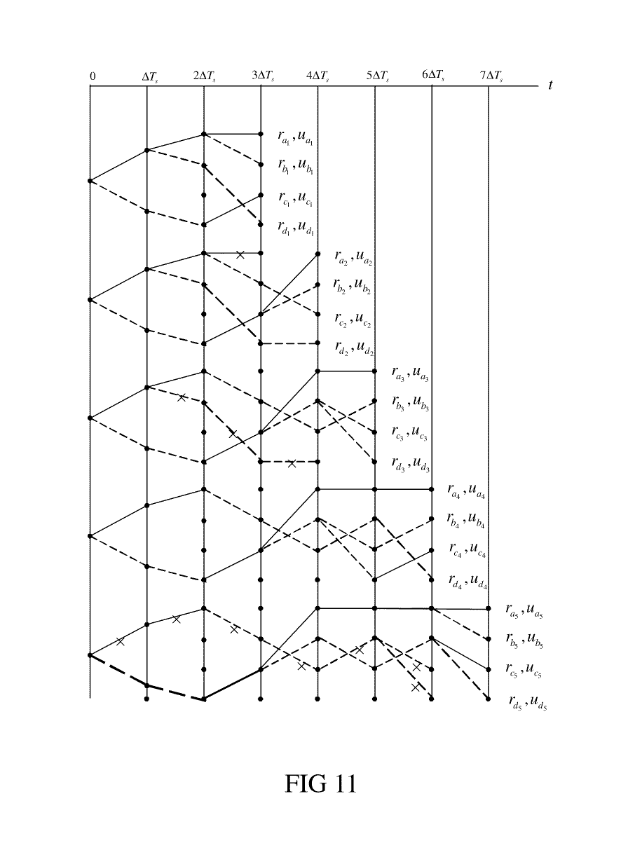

We calculate the Euclidean distances between these two paths and received signals respectively, leaving the one with a relatively small distance, which we call Survivor Path, while the other with a relatively large distance will be removed. So, to node a, we write down the Survivor Path to reach it first. Such as uₐ_{₁}=1, 1, 1 and the Euclidean distance rₐ_{₁} between uₐ_{₁} and the received signal. Similarly, to node b, there are also two paths overlapped for the first time. They are: á₀, á₀+á₁, −á₀+á₁+á₂ (corresponding to input sequence 1, 1, −1) and −á₀, á₀−á₁, −á₀+á₁−á₂ (corresponding to input sequence −1, 1, −1). We choose a path with the relatively minimum distance between it and the received signal and write down the Survivor Path, such as u_{b}_{₁}=1, 1, −1 and the Euclidean distance r_{b}_{₁} between u_{b}_{₅} and the received signal. The same procedure has been done to node c and node d with the results in FIG. 11, where ×path and the path that was not marked out mean to be eliminated. The Survivor Paths in the figure are all with the relatively minimum distances. So we have got the relatively optimal paths which can reach the node a, b, c, d and the corresponding Euclidean distances:

rₐ_{₁}′uₐ_{₁}=1,1,1)

r_{b}_{₁}′u_{b}_{₁}=1,1,−1)

r_{c}_{₁}′u_{c}_{₁}=−1,−1,1)

r_{d}_{₁}′u_{d}_{₁}=1,−1,−1)

At this stage it is still not easy for us to do any decision. When t=4ΔTₛ we respectively calculate the Euclidean distances between different paths which can arrive at all nodes and the received signal as the same, and choose the path with the relatively minimum distance. For example to node a, when t=4ΔTₛ there are four paths in original Trellis diagram which can reach node a, i.e., 1, 1, 1, 1; 1, −1, 1, 1; −1, 1, 1, 1; −1, −1, 1, 1. However, in the calculation of the first phase, the previous three branches of the second and third paths have been eliminated, so we can only make a choice between the first and the fourth paths. To this end we need to calculate the Euclidean distances respectively between them and the received signal. Now we do not need to calculate the Euclidean distance of the entire path because the noise is white noise so that we only need to calculate the Euclidean distance between the received signal and the branch from node a when t=3ΔTₛ to node a when t=4ΔTₛ, then plus rₐ_{₁} equivalent to the Euclidean distance between the first path and the received signal. Similarly, we only need to calculate the Euclidean distance between the received signal and the branch from node c when t=3ΔTₛ to node a when t=4ΔTₛ, then plus r_{c}_{₁} equivalent to the Euclidean distance between the fourth path and the received signal. Between the two paths, we eliminate the path with a relatively large distance and write down the one with a relatively small distance and its Euclidean distance rₐ_{₂} and uₐ_{₂}. Of course rₐ_{₂} and uₐ_{₂} can be removed from memory. The same procedure has been done to node b, c and node d. We will continue the procedure at every stage l in the calculation to the states represented respectively by the nodes at the stage l (l=0, 1, 2, . . . , L−K+1) (the nodes at the stage l in Trellis diagram). We only retain a path with a relatively small Euclidean distance between it and the received signal, and write down the Euclidean distance and the corresponding path.

FIG. 11 is a process diagram of the detection. Please note that, in the fifth stage of the calculation in this case, namely, when t=7ΔTₛ the Survivor Paths (that is, the relatively optimal distance) are as follows:

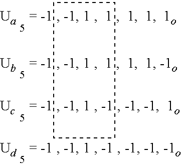

The initial parts of the relatively optimal paths at this time are all −1, −1, 1. Therefore, we can make decision:

û₀=−1, û₁=−1, û₂=1.

Because the initial parts of all the relatively optimal paths are themselves, they are naturally the optimal paths.

If the Survivor Paths have no common initial part, the calculation will continue until they have a common part. So the decision of MLSD algorithm is random. It is possible that there is not a decision output for a long time, and the decision output is not necessarily symbol-by-symbol. Maybe there is only one decision output at a time or several decision outputs at a time, but the maximum sentence is the length L+K−1 of Trellis diagram. For the system which contains L symbols and has K adjacent overlapped symbols, the length of the maximum likelihood sequence detection MLSD algorithm is up to L+K−1 steps, because the length of its Trellis diagram is up to L+K−1, and its ultimate state is all-zero (0, 0, . . . , 0), which leads to each path eventually merge.

As a result of this feature of MLSD algorithm, we will naturally have the following two questions:

First, there is a decision output in the MLSD algorithm when the Survivor Paths have common initial part, namely, a decision will go through a random delay. Well, when L→∞, what is the probability of decision delay being ∞?

Second, MLSD algorithm requires that each state has two memories. The one is used to store the Euclidean Distances of the relatively optimal paths which can arrive at the state, the other is used to store the relatively optimal paths which can arrive at the state. Then how much should the capacity of the memory be selected?

For the first question, the present inventor has proved that for the system with L→∞, the probability of its decision delay being . . . is zero (See Daoben L I, The Statistical Theory of Signal Detection and Estimation, Science Press of China, 2004).

For the first part of the second question, namely, path Euclidean distance memory, due to the existence of noise and regardless of which path, its distance from the received signal is always growing. From this point of view it seems that the capacity of the memory should be ∞. But we are just interested in the relative distance between them, so we can make its maximum (or minimum) distance zero after each calculation, i.e., the distance of each Survivor Path minus this maximum (or minimum) distance. As a result, we will only store the relative values of the distances so that its capacity is naturally limited. As to the second part of the question, namely, the Survivor Path memory, the length with 5K or 4K is enough according to the experimental results because the probability of the Survivor Path longer than 5K is basically negligible. At this time, once these memories are full but the decision has not been made, the decision can be forced out, which means that, we can take the initial bit with a minimum distance as the decision output. Sometimes Majority Logic decision can also be used, for example, we can take the majority of the initial bits of the Survivor Paths as the decision output. The equipment of the latter is very simple but the performance is slightly worse than the first approach. However the probability of forced decision is very small, and as a result the caused performance loss is also small.

From above studies, we find that different from any other communication technologies, the signal detection of the Overlapped Time Division Multiplexing system should be handled with in the time domain, and the optimal way to deal with the issue is digital. This requires the receiver of the system performing discrete and digital processing to the received signals first. Interestingly, it is generally believed that the overlapped symbol would have serious mutual interference. The present inventor found that the overlapped symbol not only does not produce interference, but can be used as the coding constraint relation. The more serious the symbols are overlapped and the longer the coding constraint is, the higher the coding gain will be. Of course, such coding is a naturally formed coding relation instead of the optimal coding constraint relation. The present inventor firmly believes, without any doubt, that the overlapped symbol multiplexing with the appropriate coding, which can form the optimal coding relation, will further improve the system performance.

The present inventor has theoretically proved and verified by a large number of computer simulation that in the random time-varying channel, for the fixed width B₀ of symbol bandwidth and the fixed symbol length Ts, we can reduce the symbol interval ΔTₛ to increase the overlapped number K. The inventor found the system bandwidth unchanged at this time, the spectrum efficiency of the system would proportionally increase with K, but the transmission reliability of the system (the order of diversity) would be basically unchanged. However, if the total bandwidth B of the system is proportionally increased at the same time (the rectangular or broadband symbols can be overlapped first and then filter or other means such as spread spectrum and CDMA to achieve), the spectrum efficiency of the system will be basically unchanged while the performance is indeed improving much and the transmission reliability is getting higher and higher. At this time, when K→∞, the random time-varying channel will be gradually transformed into the parametric stabilization Additive White Gauss Noise channel with the optimal channel performance, i.e., AWGN channel. Therefore, in the random time-varying channel, as long as the linearity and transmitting power of the system are guaranteed, we can boldly utilize the approach increasing the overlapped number K to improve the spectral efficiency or the transmission reliability of the system, or both. Of course, the processing complexity of the system will also increase.

The following implementations of example 1 and example 2 are used to explain the approach and the system of Overlapped Time Division Multiplexing respectively.

### The Implementation of Example 1

Through the implementation of the following example, we illustrate the implementation steps in the approach of Time Division Multiplexing described in the present invention.

Step 1: according to the given channel parameters and system parameters, determine a number of basic design parameters:

1) Channel parameters: mainly, the channel's maximum volume of time spread Δ (second) or the channel's coherence bandwidth

$${Ω}^{o} = \frac{1}{Δ} ( Hz ) ;$$

the channel's largest volume of frequency spread [symbol] (Hz) or the channel's coherence time

$${t}^{o} = \frac{1}{{F}^{o}} ( second ) ;$$

2) System parameters: mainly, system bandwidth B (Hz); the requirements on the spectrum efficiency; linearity, etc;

3) Design Parameters:

a) The number of basic modulation level M=2^{Q}, where: Q is the number of bits loaded by each modulated symbol.

At the same spectral efficiency, the complexity of the system are not relevant to M, which can be properly selected according to the specific circumstances. The complexity of the system is determined by the number of steady states, i.e., 2^{Q(K-1)}=M^{K-1}.

According to (1) and (2), given time-bandwidth product B₀Tₛ, the number of steady state is basically determined by spectrum efficiency.

b) The length of the basic symbol [symbol] (s) (the length of the symbol Tₛ= [symbol] +A), the spectrum width of the basic modulated signal B₀ (Hz);

To reduce the complexity of the system, we can make [symbol] Δ so that in the random time-varying channel the number of steady states of the system will remain basically unchanged to facilitate the realization of the project;

If we only concern the transmission reliability of the system instead of the changes of the number of states or the complexity of the system, we can make [symbol] be comparable to or even less than Δ;

B₀ is larger and Tₛ is longer. In the random time-varying channel the hidden diversity gain will be automatically generated to improve the performance of the system, where:

the order of hidden frequency diversities: K_{f}⁰=└B₀Δ+1▪;

the order of hidden time diversities: Kₜ⁰=└ [symbol] Tₛ+1┘;

The total order of uncorrelated diversities of the system K=Kₜ⁰K_{f}⁰ is the product of the two (If there is space diversity, the product will contain the order of space diversity Kₛ⁰).

Where, └ ┘ is the minimum positive integral of

c) the relative shift amount of symbols (symbol interval) ΔTₛ or the overlapped number of symbols K:

For the smaller ΔTₛ, the larger K will improve the spectrum efficiency of the system, but the complexity of the system and the number of the allowed level both have a corresponding increase, which should be determined according to the actual situation and needs. The basic relation is as follows:

(K−1)ΔTₛ<Tₛ≦KΔTₛ

Where: in addition to the width of the basic symbols [symbol] , Tₛ should also include the largest amount of time expansion Δ (multipath spread) of the system and other time expansion factors.

When ΔTₛ is far less than the coherence time of the channel

$${t}^{o} = \frac{1}{{F}^{0}} ,$$

in the channel model of the overlapped time system, the shift tap coefficients ã_{l-k,k}(t) will be contracted to some sample (value), on the contrary they will be some time waveform.

d) The total number of symbols of the system L (or the frame length T)

where, the frame length of the system T=Tₛ+(L−1)ΔTₛ,

$$L = \frac{T - {T}_{s}}{Δ {T}_{s}} + 1$$

In the specific system design, it is optimal to make the frame length be less than the coherence time of the channel

$${t}^{o} = \frac{1}{{F}^{0}} ,$$

namely, T< [symbol] . Therefore within the total frame length T, the features of the channel will remain basically unchanged to facilitate the realization of system engineering and the arrangement of pilot signals.

When given system and channel parameters, design parameters B₀, ΔTₛ, K, L, Tₛ and the total bandwidth B of the system, etc, interact on and are closely linked to each other, which should be repeated and optimized in the design according to the actual situation.

The spectral efficiency of the system η is:

$$η = \frac{LQ}{{B}_{0} {T}_{s} + {B}_{0} ( L - 1 ) Δ {T}_{s}}$$

When given T and K, the smaller ΔTₛ and thus the smaller Tₛ will result in the larger L and the higher η;

Too small B₀ will result in the order of natural hidden frequency diversities K_{f}⁰=└B₀Δ+1┘ of the system decreasing. But as long as the total bandwidth B of the system is wide enough (through spread spectrum, CDMA, multicarrier or other means to achieve the wider total bandwidth B), there is no need to take account of it in the design because we can still improve the order of hidden frequency diversities of the system by interweaving, coding and other technical means. For the system, its order of hidden diversity is determined by └BΔ+1┘ rather than └B₀Δ+1┘, but the latter will be naturally formed, while the former is subject to additional technical means to get it.

Step 2: according to the given channel characteristics, system parameters and design parameters, design the Transmitter system of Overlapped Time Division Multiplexing.

Because Overlapped Time Division Multiplexing technology is the same as other multicarrier technology such as OFDM in terms of the parallel synchronous data transmission system except that their means of demodulation and detection are completely different. For each symbol, the structure of its transmitter is basically the same as the traditional digital communication transmitter.

FIG. 12 is the schematic diagram of the transmitter of a Overlapped Time Division Multiplexing (no DS or CDMA) system. For the spread spectrum or CDMA system, the part of spread-spectrum operations can be added. In the l (=0, 1, 2, . . . , L−1) symbol time interval, the complex envelope of the operations achieved by the transmitter (no spread-spectrum operation) is:

$$\sqrt{2 {E}_{0}} {\sum }_{l = 0}^{L - 1} {\tilde{u}}_{l} \tilde{a} ( t - l Δ {T}_{s} ) , \\ t ∈ [ 0 , T ]$$

Where, E₀ is the emission energy of each symbol; ã(t) is the envelope of the normalized complex modulated signal, and it meets

ã(t)=0, t∉[0,Tₛ]
∫₀^{T}^{ₓ}|ã(t)|²dt=1;
ũₗ=Iₗ+jQₗ is the complex data transmitted by the l (l=0, 1, . . . , L−1) symbol.

Where, the spectrum of the complex basic modulated signal ã(t) is A(f) and its bandwidth is B₀ Hz, that is

$$\tilde{A} ( f ) = 0 , \\ f ∉ [ - \frac{{B}_{0}}{2} , \frac{{B}_{0}}{2} ]$$

The basic point in the diagram is the formation of the in-phase a_{c}(t) and orthogonal aₛ(t) waveform of the envelope waveform ã(t)=a_{c}(t)+jaₛ(t) of the complex modulated signal in l=0 path by digital means first. The in-phase and orthogonal envelope waveform of other modulated signal in l=1, 2, . . . , L−1 paths will be got when the in-phase a_{c}(t) and orthogonal aₛ(t) waveform pass through the shift register. The modulated signal waveform after data modulation and filtering of each modulated signal is generated by the product of the in-phase and orthogonal envelope waveforms of each referred modulated signal and the in-phase and orthogonal data symbols of each corresponding signal. To add each referred modulated signal waveform, the emission signal will be formed. It ensures the consistency of the complex envelope of each signal.

Step 3: the formation of symbol time synchronization in the receiver and the processing of the received signal \tilde{v}(t),t∈[o,T] in each frame under the synchronization condition.

The basic steps are as follows:

According to the sampling theorem, we can select the appropriate sampling frequency, process the received signal digitally and form the digital sequence in time domain of the received signal. Digitalized processing can be carried out in the intermediate frequency or in baseband, which is completely determined by the designer. If the designer is willing to use non-digital analog form to handle the problem, of course, it can also be removed from digitalized processing to process analog signals directly.

Step 4: measure the actual channel and find out the valuation of the complex envelope ã(t−lΔTₛ) of the received signal within different symbol time interval.

Any methods can be used on the valuation of ã(t−lΔTₛ), such as the use of the special “pilot signal” to measure, or the use of the decided information through the approach of the computing on the received signal to calculate its valuation, or a combination of both, or even the method of blind estimation to solve its valuation.

Step 5: use the valuation of ã(t−lΔTₛ) found in Step 4 to form the tap coefficient ã_{l-k,k}(t) in the channel model of Overlapped Time Division Multiplexing system.

Step 6: According to the number M=2^{Q} of the basic modulation levels used by the system and the overlapped number K, list all the states of the system; the states contain the initial state, the final state, the former transition state, the latter transition state and the steady state, a total of five. The so-called state S is the Q-dimension binary data (+ or −) or the zero data which is corresponded to the modulated data [ũₗ₋₁, ũₗ₋₂, . . . ũ_{l-K+1}] stored in the channel model of the time-domain shift register, where: ũₗ≡0, ∀l>L−1;

The initial and the final state are both single and both are:

$$\underbrace{[ \overbrace{00 … 0}^{Q } , \overbrace{00 … 0}^{Q } , … , \overbrace{00 … 0}^{Q } ]}_{K - 1 }$$

(They are the states with all the Q dimension data zero);

There are 2^{Q(K-1)}=M^{K-1} steady states and they are:

$$\begin{matrix}[ \overbrace{++ … +}^{Q } , \overbrace{++ … +}^{Q } , … , \overbrace{++ … +}^{Q } ] \\ [ ++ … + , ++ … + , … , ++ … - ] \\ … \\ \underbrace{[ -- … - , -- … - , … , -- … - ]}_{K - 1 }\end{matrix}$$

(They are the states with all the Q dimension data binary (+ or −) data).

The former and the latter transition states both have

M+m²+M³+ . . . +M^{K-2}.

The so-called former transition states are the states with the former several (but less than K−2) Q-dimension data zero.

The so-called latter transition states are the states with the latter several (but less than K−2) Q-dimension data zero.

Initial state can only transfer to the 2^{Q} former transition states. If K=2, then it can transfer directly to the 2^{Q} steady states;

Final state can only be transferred from the previous 2^{Q} latter transition states. If K=2, then it can be transferred directly from 2^{Q} steady states;

The forward transition state can only be transferred from a previous state (the initial state or the former transition state), but can transfer to the rear 2^{Q} states (the former transition state or the steady state) transfer; The forward transition state only exists in Trellis diagram when node l<K−1.

The backward transition state can be transferred from the previous 2^{Q} states (the former transition state or the steady state), but can only transfer to a rear state (the latter transition state or the final transition state) transfer. The backward transition state only exists in Trellis diagram when node l>L−1.

Because each time the new Q-dimension binary or zero new data always comes into the channel model while the previous K−1 Q-dimension zero or binary old data leaves the channel model at the same time, and the Q-dimension binary data has 2^{Q} combination but the Q-dimension zero data only has one possibility, therefore there is the aforementioned relation of the state transition.

Transition state is the characteristic of Overlapped Time Division Multiplexing which is different from the corresponding finite state machine of the general convolution codes or Trellis code.

Step 7: According to the relation of the state transfer, make the state diagram, Trellis diagram or tree diagram of the system and calculate the coding output \tilde{S}_{1,S,m}(t) of each transfer branch in terms of (4) to (6) respectively, that is:

$${\tilde{S}}_{l , s , m} ( t ) = \frac{1}{2} \sqrt{2 {E}_{s}} {\sum }_{k = 0}^{Min ( l , K - 1 )} {\tilde{u}}_{l - k} {\tilde{a}}_{l - k , k} ( t )$$

Where: l∈(0, 1, 2, . . . , L−K+1) indicates the inputted l symbol, but
when l>L−1, ũₗ≡0;
S indicates the state that the transfer branch has reached at node l;
m indicates the path through which it cam reach the state. For the former transition state m=1; other states m=2^{Q}=M;

Because Trellis diagram will finish until it reaches the node L−K+1, l may be greater than L−1 in (4). But when it reaches the node L−K+1, it is inevitable for Trellis diagram to contract into the final all-zero state.

Step 8: For each steady state S, two memories should be prepared. One is used to store the Survivor Path U_{S,l}=[u_{S,0}, u_{S,1}, . . . , u_{S,l}], l=0, 1, . . . , L+K−1 that arrived at the state S, where u_{S,l} is the Q-dimension binary data; the other is used to store the path Euclidean distance d_{S,l}, (l=0, 1, 2, . . . , L−K+1) between the corresponding coding output before node l of the Survivor Path U_{S,l} and the received signal sequence \tilde{v}ₙ(t)=[\tilde{v}₀(t), \tilde{v}₁(t), . . . , \tilde{v}_{L+K-1}(t)].

For the transition state, the memories of any steady state can be borrowed temporarily. As a result of the steady state with the kind of 2^{Q(K-1)}=M^{K-1}, each kind of memories will be needed M^{K-1}, a total of 2M^{K-1}.

Step 9: in Trellis diagram, the maximum likelihood sequence detection MLSD is implemented, and its sub steps are as follow:

1′) Let the path Euclidean distance of the state (l=0) of the initial node d_{0,0}=0;

2′) For all the states S at node l (l=1, . . . , L−K+1), calculate the branch Euclidean distance d_{S,m}(l,l+1) between the branch coding signal of all the m(m=1 [symbol] 2^{Q}=M) paths from the previous state to this state and the received signal sequence \tilde{v}ₗ(t).

d_{S,m}(l,l+1) ∫_{lΔT}_{ₛ}^{(l+1)ΔT}^{ₛ}|\tilde{V}_{n,l}(t)−\tilde{S}_{l,S,m}(t)|²df (12)

3′) For each state S, add the branch Euclidean distance d_{S,m}(l,l+1) that reached this state and the path Euclidean distance d_{S′,l-1} of the state S′ where they come from respectively, to form m new path Euclidean distance, and choose the minimum one as the path Euclidean distance d_{S,l} of the state S at node l, updating and storing into path Euclidean distance memory of the state S.

4′) At node l (l=1, 2, . . . , L−K+1), for each state S, find out the corresponding Survivor Path U_{S,l} of the path Euclidean distance, updating and storing into the Survivor Path memory of the state S.

For node l+1, repeat sub step 2′), 3′), 4′) until node l=L+K−2. At this time the only one Survivor Path is bound to be left, and then the corresponding data sequence of the Survivor Path is just the final decision output that we need.

5′) When L is large, in order to use the shorter Survivor Path memory, its length can be set at 4K˜5K. At this time the Survivor Path memory of each state can be checked at any time in the sub step 4. Once the same initial part is found in paths stored in the memories, the same initial part will be regarded as the decision output and meanwhile the corresponding storage space will be vacated.

6′) In order to reduce the capacity of the memory of path Euclidean distance of each state S and avoid overflow, we can make the minimum (maximum) one of the path Euclidean distance as zero distance after the completion of each step, with which the difference values (positive or negative) are stored by the Euclidean distance memories of the other states, that is, the relative Euclidean distance.

Step 10: When the overlapped number K is too large, although step 9 can bring the optimal performance, that is, it can find out the path that has the genuine minimum Euclidean distance with the received signal, the use of step 9 will lead to the sequence detector too complicated for the too large K. At this time the other fast sequence decoding algorithm in convolution coding can be considered to reduce the complexity of the sequence detector, but it is necessary to transform them completely in order to adapt to the Overlapped Time Division Multiplexing system. However, the reduction of the complexity of any sequence detection is at the expense of the sacrifice of the threshold signal-to-noise ratio of the system.

The implementation of example 2

Through the implementation of the following example, we illustrate the Time Division Multiplexing system of the present invention.

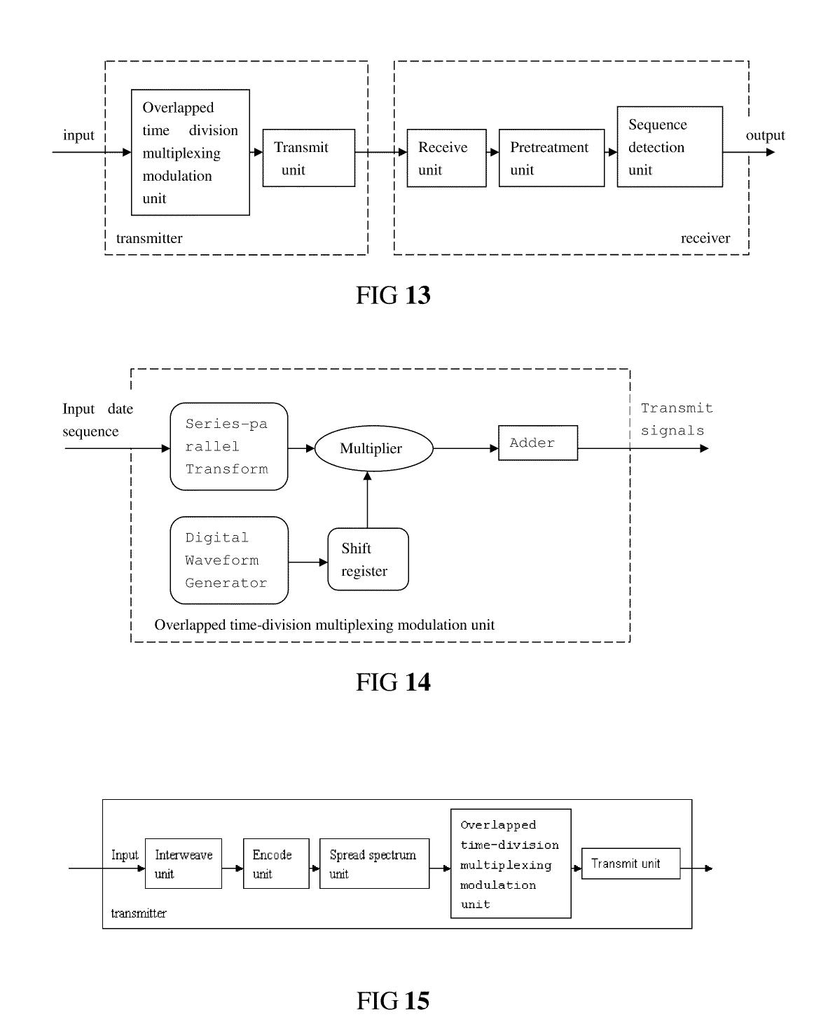

The Time Division Multiplexing system provided by the present invention is shown in FIG. 13, including the transmitter and the receiver, where the transmitter also includes the modulation unit and emission unit of the Overlapped Time Division Multiplexing; the receiver includes receiving unit, preprocessing unit and sequence detection unit.

In the transmitter, the input data sequence passes through the modulation unit of the Overlapped Time Division Multiplexing to form the emission signal overlapped by a number of symbols in the time domain, and then the described emission signal is transmitted by the emission unit to the receiver; the receiving unit of the receiver receives the signal transmitted by the emission unit, then the signal passes the preprocessing unit to form the received digital signal which is adaptive for the sequence detection unit to detect, and furthermore the sequence detection unit does data sequence detection in the time domain for the received signal, thus the output decision is carried out.

The block diagram of the modulation unit of the Overlapped Time Division Multiplexing of the transmitter in the present invention is shown in FIG. 14, the modulation unit of the Overlapped Time Division Multiplexing includes the digital waveform generator, shift register, the serial-parallel converter, multiplier and adder.

First of all, the in-phase and orthogonal waveform of the envelope waveform of the first modulated signal is formed digitally by the digital waveform generator; the in-phase and orthogonal waveform of the envelope waveform of the first modulated signal formed by the digital waveform generator is shifted by shift register to generate the in-phase and orthogonal envelope waveform of other various modulated signals; then, the serial input data sequence will be converted to the parallel in-phase and orthogonal data signals of the corresponding various modulated signals by the serial-parallel converter; the described in-phase and orthogonal data signals output by the serial-parallel converter time the in-phase and orthogonal envelope waveforms of the various corresponding modulated signals by the multiplier to obtain the modulated signal waveform after data modulation and filtering of each modulated signal; finally, to add by the adder the modulated waveform after data modulation and filtering of each modulated signal output by the multiplier, emission signal will be formed.

Another design block diagram of the transmitter in the present invention is shown in FIG. 15. The difference from the transmitter in FIG. 13 is that this transmitter also includes interwoven unit, coding unit and spread spectrum unit in addition to including the modulation unit of the Overlapped Time Division Multiplexing.

Where, spread spectrum unit is used to increase the total bandwidth of the system so that it has the same effect of the interwoven unit and the coding unit, thereby the order of hidden frequency diversities or the order of hidden time diversities of the system is increased.

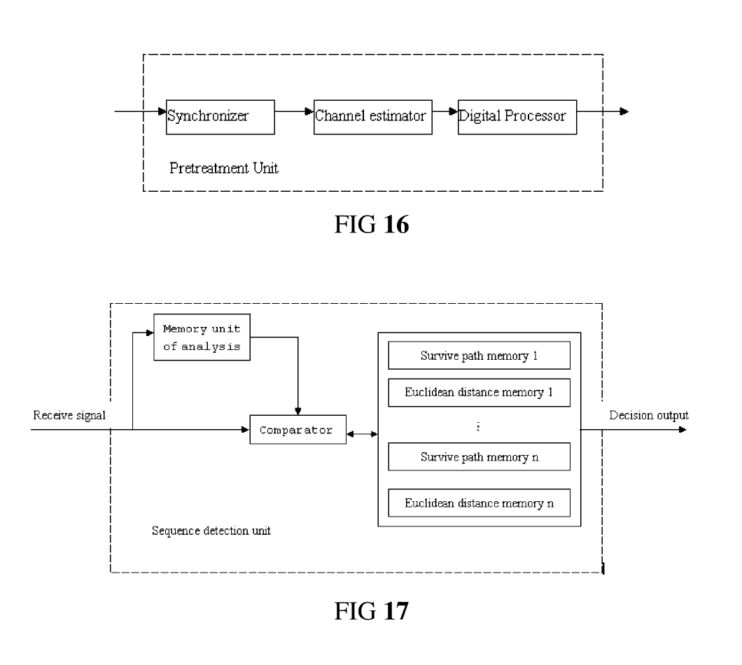

The block diagram of the preprocessing unit of the receiver in the present invention is shown in FIG. 16. The preprocessing unit is used to form the synchronized received digital signal sequence in each frame, including the synchronizer, the channel estimator and the digital processor. Where, the synchronizer is used for the received signal to form the symbol time synchronization in the receiver; then the channel estimator estimates the channel parameters; the digital processor is used for the received signal in each frame to be processed digitally, therefore the received digital signal sequence is formed which is adaptive for the sequence detection unit to do sequence detection.

The block diagram of the sequence detection unit of the receiver in the present invention is shown in FIG. 17. The sequence detection unit includes the memory of the analysis unit, comparator and a number of the Survivor Path memory and the Euclidean distance memory or the weighted Euclidean distance memory (not to be shown in the figure). In the detection process, the memory of the analysis unit makes the complex convolution coding model and the Trellis diagram of Overlapped Time Division Multiplexing system, and lists and stores all the states of Overlapped Time Division Multiplexing system; according to the Trellis diagram in the memory of the analysis unit, the comparator searches for the path with the minimum Euclidean distance or the weighted minimum Euclidean distance compared with the received digital signal; however the Survivor Path memory and the Euclidean distance memory or the weighted Euclidean distance memory are respectively used to store the Survivor Path and the Euclidean distance or the weighted Euclidean distance output by the comparator. Thus, the described Survivor Path memory and the Euclidean distance memory or the weighted Euclidean distance memory should be prepared for each stable state. The length of the described Survivor Path memory can be optimized for 4K˜5K. The described Euclidean distance memory or the weighted Euclidean distance memory can be optimized for only the relative distance.

The method and system of time division multiplexing technology of the present invention is not meant to be limited to the aforementioned prototype system, and the subsequent specific description utilization and explanation of certain characteristics previously recited as being characteristics of this prototype system are not intended to be limited to such technologies.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A method of Time Division Multiplexing utilizing a number of symbols in the time domain transmitting data sequence in parallel, said method comprising:
a) The transmitting terminal forming the transmission signals overlapped by a number of symbols in the time domain, and
b) The receiving terminal handling the data sequence detection in the time domain for the received signals according to the one-to-one relationship between the transmission data sequence and the time waveform of the transmission data sequence.

2. The method as recited in claim 1 wherein said transmitting terminal forms the transmission signals overlapped by a number of symbols in the time domain according to design parameters.

3. The method as recited in claim 2 wherein said design parameters are determined by the given channel parameters and system parameters.

4. The method as recited in claim 3 wherein said design parameters include the number of the basic modulation levels M, the length of the basic symbols [symbol] , the length of the symbols Tₛ, the symbol interval ΔTₛ, the symbol overlapped number K and the frame length T.

5. The method as recited in claim 3 wherein said overlapped symbol number K, said symbol interval ΔTₛ and said length of the symbols Tₛ has the following relationship: (K−1)ΔTₛ<Tₛ≦KΔTₛ.

6. The method as recited in claim 4 wherein said length of the symbols Tₛ= [symbol] +Δ, where [symbol] is the length of the basic symbols, Δ is the channel's maximum volume of time spread.

7. The method as recited in claim 4 wherein said length of the basic symbols [symbol] is equal to or less than the channel's maximum volume of time spread Δ.

8. The method as recited in claim 4 wherein said symbol interval ΔTₛ is less than the coherence time [symbol] of the channel.

9. The method as recited in claim 4 wherein said frame length T< [symbol] , where [symbol] is the coherence time of the channel.

10. The method as recited in claim 4 wherein said overlapped number K is increased by reducing the symbol interval ΔTₛ.

11. The method as recited in claim 3 wherein said channel parameters include the channel's maximum volume of time spread Δ or the channel's coherence bandwidth [symbol] and the channel's maximum volume of frequency spread [symbol] or the coherence time of the channel [symbol] .

12. The method as recited in claim 3 wherein said system parameters include the system bandwidth B, the requirements of the spectral efficiency and the linearity.

13. The method as recited in claim 1 wherein said the order of hidden frequency diversities of the system is improved by increasing the system bandwidth B, or the use of the method of interweaving and encoding, or improving the system data rate or in the way of the expansion of the signal spectrum.

14. The method as recited in claim 1 wherein said transmitting terminal forms the transmission signals overlapped by a number of symbols in the time domain, said method comprising:
a) Forming digitally the in-phase and orthogonal waveforms of the envelope waveform of the modulated signal in l=0 path;
b) Forming the in-phase and orthogonal envelop waveforms of other various modulated signals after said in-phase and orthogonal waveforms are time-shifted,
c) Generating the modulated signal waveform after data modulation and filtering of each modulated signal is generated by the product of the in-phase and orthogonal envelope waveforms of each referred modulated signal and the in-phase and orthogonal data symbols of each corresponding signal, and
d) Forming said transmission signal by adding each said modulated signal waveform.

15. The method as recited in claim 1 wherein said receiving terminal managing data sequence detection in the time domain for the received signals according to the one-to-one relationship between the transmission data sequence and the time waveform of the transmission data sequence, said method comprising:
a) Forming the received digital signal sequence is formed for the received signals in each frame, and
b) Performing sequence detection for said received digital signal sequence to obtain the decision of the modulation within said frame length on the modulation data of all the symbols.

16. The method as recited in claim 15 wherein said received signals in each frame, the formation of the received digital signal sequence further comprising:
a) Forming the symbol time synchronization for the received signal at the receiver,
b) Processing said received signal in each frame digitally according to the sampling theorem.

17. The method as recited in claim 16 wherein said digitalized processing can be carried out in the intermediate frequency or in baseband.

18. The method as recited in claim 1 wherein said sequence detection is the maximum likelihood sequence detection when each sequence has the equal probability.

19. The method as recited in claim 15 wherein said received digital signal sequence doing sequence detection, said method comprising:
a) Making the complex convolution coding model of the Overlapped Time Division Multiplexing system,
b) Listing all the states of the Overlapped Time Division Multiplexing system,
c) Making the Trellis diagram of the Overlapped Time Division Multiplexing system, and list the coding output of each branch;
d) Having two memories get ready for each steady state, and
e) Searching for the path with the minimum Euclidean distance or the weighted minimum Euclidean distance compared with said received digital signal sequence, and taking the corresponding data sequence of the path as the final decision output in said Trellis diagram.

20. The method as recited in claim 19 wherein making said complex convolution coding model of the Overlapped Time Division Multiplexing system, said method comprising:
a) Measuring the actual channel and find out the valuation of the complex envelope of the received signal within different symbol time interval,
b) Using said valuation of the complex envelope of the received signal to form the tap coefficient in the channel model of Overlapped Time Division Multiplexing system.

21. The method as recited in claim 20 wherein said measuring actual channel and finding out the valuation of the complex envelope of the received signal within different symbol time interval can be obtained by using the special pilot signal or by the use of the decided information through the approach of the computing on said received signal to calculate its valuation, or by a combination of both, or by the method of blind estimation to solve its valuation.

22. The method as recited in claim 19 wherein said states of the Overlapped Time Division Multiplexing system include the initial state, the former transition state, the steady state, the latter transition state and the final state.

23. The method as recited in claim 19 wherein for each said steady state, two said memories should be prepared, of which the Survivor Path memory is used to store the Survivor Path that arrived at the described state; the Euclidean distance memory or the weighted Euclidean distance memory is used to store the Euclidean distance or the weighted Euclidean distance between the Survivor Path that arrived at the described state and the received digital signal sequence.

24. The method as recited in claim 19 wherein said memories of any steady state can be borrowed by said transition state.

25. The method as recited in claim 19 wherein said Trellis diagram, searching for the path with the minimum Euclidean distance or the weighted minimum Euclidean distance compared with said received digital signal sequence, said method comprising:
a) Letting the path Euclidean distance or the path weighted Euclidean distance of the state (l=0) of the initial node zero;
b) Calculating the branch Euclidean distance or the branch weighted Euclidean distance between the branch coding signal of all the paths from the previous state to the described state S and said digital signal for all said states S at node
l (l=1, . . . , L−K+1),
c) Adding said branch Euclidean distance or the branch weighted Euclidean distance that reached this state and the path Euclidean distance or the path weighted Euclidean distance of the state S′ where they come from respectively, to form one or many new path Euclidean distance or the path weighted Euclidean distance; if there are more than one described path Euclidean distance or path weighted Euclidean distance, choose the minimum one as the path Euclidean distance or the path weighted Euclidean distance of the state S at node l, updating and storing into the Euclidean distance memory or the weighted Euclidean distance memory of the described state S,
d) Finding out the corresponding Survivor Path of the path Euclidean distance or said path weighted Euclidean distance at node l for each state S, updating and storing into the Survivor Path memory of the state S and
e) Repeating the above steps for the next node until node L+K−2 when the only one Survivor Path is left, and then the corresponding data sequence of the Survivor Path is the final decision output.

26. The method as recited in claim 25 wherein said Survivor Path memory of each state can be checked at any time and once the same initial part is found in stored paths, the same initial part will be regarded as the decision output.

27. The method as recited in claim 26 wherein said Survivor Path memories are full but the decision has not been carried out, the decision can be forced out, that is, we can take the initial bit with a minimum distance as the decision output.

28. The method as recited in claim 26 wherein when said Survivor Path memories are full but the decision has not been carried out, the Majority Logic decision can be used, that is, we can take the majority of the initial bits of the Survivor Paths as the decision output.

29. The method as recited in claim 25 wherein said path Euclidean distance memory or weighted Euclidean distance memory only stores the relative distance, that is, we can take the minimum or maximum one of the path Euclidean distances or weighted Euclidean distances as zero distance and the relative Euclidean distance or relative weighted Euclidean distance, which is the difference value with the minimum or maximum one of the described path Euclidean distances or path weighted Euclidean distances, is just stored by the path Euclidean distance memory or weighted Euclidean distance memory of each other state.

30. The method as recited in claim 1 wherein said sequence detection is the maximum a posteriori probability sequence detection when each sequence has the unequal probability.

31. A Time Division Multiplexing system of both transmitter and receiver, said system includes comprising:
a) The modulation unit of the Overlapped Time Division Multiplexing, which is used to form the emission signal overlapped by a number of symbols in the time domain,
b) The transmission unit, by which the described emission signal is transmitted to the receiver;
c) The receiving unit used to receive the signal transmitted by said transmission unit;
d) The sequence detection unit, which is used to do data sequence detection in the time domain for the received signal.

32. The system as recited in claim 31 wherein said modulation unit of the Overlapped Time Division Multiplexing includes:
a) The digital waveform generator generating the in-phase and orthogonal waveform of the envelope waveform of the first modulated signal is formed digitally;
b) The shift register by which the in-phase and orthogonal waveforms of the envelope waveform of the first modulated signal formed by the digital waveform generator are shifted to generate the in-phase and orthogonal envelope waveforms of other various modulated signals;
c) The serial-parallel converter converting the serial input data sequence will be converted to the parallel in-phase and orthogonal data signals of the corresponding various modulated signals;
d) The multiplier multiplying said in-phase and orthogonal data signals output by the serial-parallel converter time the in-phase and orthogonal envelope waveforms of the various corresponding modulated signals to obtain the modulated signal waveform after data modulation and filtering of each modulated signal;
e) The adder summing up said modulated waveform after data modulation and filtering of each modulated signal output by the multiplier, and forming said transmission signal.

33. The system as recited in claim 32 wherein said transmitter also includes the spread spectrum unit to increase the total bandwidth of the system.

34. The system as recited in claim 32 wherein said transmitter also includes interwoven unit and coding unit to increase the order of hidden frequency diversities or hidden time diversities of the system.

35. The system as recited in claim 31 wherein said receiver also includes the preprocessing unit to form the synchronized received digital signal sequence in each frame.

36. The system as recited in claim 35 wherein said preprocessing unit further comprising:
a) The synchronizer, which is used for the received signal to form the symbol time synchronization in the receiver;
b) The channel estimator, which is used to estimate the channel parameters;
c) The digital processor, which is used for the received signal in each frame to be processed digitally.

37. The system as recited in claim 31 wherein said sequence detection unit further comprising:
a) The memory of the analysis unit, which makes the complex convolution coding model and the Trellis diagram of Overlapped Time Division Multiplexing system, and lists and stores all the states of Overlapped Time Division Multiplexing system;
b) The comparator searching for the path with the minimum Euclidean distance or the weighted minimum Euclidean distance compared with the received digital signal according to the Trellis diagram in the memory of the analysis unit;
c) The Survivor Path memory of the steady state S, which is used to store the Survivor Path that arrived at the described steady state S;
d) The Euclidean distance memory or the weighted Euclidean distance memory of the steady state S used to store the relative Euclidean distance or the relative weighted Euclidean distance that arrived at the described steady state S between the Survivor Path and the received digital signal sequence where said the steady state S is any one of all the described steady states.

38. The system as recited in claim 37 wherein said each state has a Survivor Path memory and a Euclidean distance memory or the weighted Euclidean distance memory and the memories of any steady state can be borrowed by the transition state.

39. The system as recited in claim 38 wherein said the length of the described Survivor Path memory is 4×K to 5×K, where K is the overlapped number.

40. The system as recited in claim 38 wherein the length of said Survivor Path memory is less than 4×K or more than 5×K, where K is the overlapped number.

41. The system as recited in claim 38 wherein said Euclidean distance memory or the weighted Euclidean distance memory only stores the relative distance.
